(19) United States
(12) Patent Application Publication
(10) Pub. No.: US 2014/0310288 A1
(43) Pub. Date: Oct. 16, 2014

(54) METHOD AND SYSTEM FOR ALLOCATION OF RESOURCES

(71) Applicant: ChaCha Search, Inc, Carmel, IN (US)

(72) Inventors: Jeffrey Jockisch, Westfield, IN (US); Rich Loomis, Fishers, IN (US); Eugene Murphy O'Donnell, Fishers, IN (US)

(73) Assignee: ChaCha Search, Inc, Carmel, IN (US)

(21) Appl. No.: 14/252,859

(22) Filed: Apr. 15, 2014

Related U.S. Application Data
(60) Provisional application No. 61/811,906, filed on Apr. 15, 2013.
(60) Provisional application No. 61/812,122, filed on Apr. 15, 2013.

(51) Int. Cl. G06F 17/30

(52) U.S. Cl. CPC G06F 17/3053
USPC 707/748

(57) ABSTRACT

A system and method for allocating resources including responders for responding to a request is described. A resource may be allocated based on a request, a user, availability of a responder, availability of a paid responder, a value associated with responding to a request, and a type of resource which is used to respond. Resources may be directed to a request based on expected success, popularity of a request, expected and/or actual reuse of a request, a type of request and a type of information sought.

### BACKGROUND

1. Field of the Invention

The present invention is related to distribution of requests to human assistants and resource allocation.

2. Description of the Related Art

In a system of processing requests routing of questions to responders may be critical to success. Various methods have been developed for routing a request to an expert or responder to provide an answer. In some instances, a question is routed based on content of the request such as keywords. Recipients of requests may be associated with keywords and the queries may be touted based on whether content of the query indicates keywords for which a responder has registered. Systems such as the ChaCha search engine, Aardvark, and U.S. Pat. No. 6,901,394 have used keyword based routing for various purposes.

However, keyword routing may have weaknesses as well. In some instances a query may be location specific, and may not be directed to a best responder based on keywords alone. For example US Pub. 2003/0140037 describes a method to route a query based on location information as well as content of the query. Likewise characteristics of a responder such as demographic, geographic, affiliation, psychometric, and other characteristics may be used to optimize selection of a responder such as per US Pub. 2009/0100047.

Such routing methodologies may be effective at selecting a best responder, but may have problems if the optimum responder is not available. To overcome this problem, a progressively less selective choice of responder may be used in order to locate a responder who can reply within a given time interval. Systems such as that described in U.S. Pat. No. 8,065,286 may use such a method with good effect.

Unfortunately, there may be limited responders available in any case. In such an instance, the time to respond to a request may become unacceptably long. Use of paid responders may mitigate this problem, but may have an unacceptably high cost.

For these and other reasons a method and system for allocating resources to respond to a request would be greatly appreciated.

### SUMMARY

A system is provided which includes user devices for submitting a request for information or query, responder devices which may function as user devices for providing answers or responses, a query server which receives and routes queries and responses, resources which may be used to provide information of responses to answerers and/or users, and a database comprising records of users, responders, resources, questions, answers, and other information associated with processing of a query.

If a query is received, the query may be classified in various ways. For example, a query may be assigned an expertise rating which may indicate a level of difficulty associated with a query. An expertise rating may relate to whether a query is seeking factual information, a degree of difficulty associated with the factual information, and other factors. A degree of difficulty may be assigned based on factors such as keywords of a query, historical information of a user, a number of responders associated with a topic of a query, a number of queries submitted regarding a category and/or keyword of a query, named entities associated with the query, etc. A person may assign a degree of difficulty to a query. A degree of difficulty may be assigned based on a user submitting a request. For example, if a user submitting a request has previously responded to requests associated with similar topics to a request the degree of difficulty may be assigned as higher than the expertise rating of the user. Similarly, if requests of a user associated with a particular topic have received answers from responders with a particular rating, a request submitted by the user may receive a degree of difficulty rating based on that.

A received query may be assigned a popularity rating. For example if a category, keyword, etc. of a query is used frequently a popularity rating of a query may be increased. Likewise, if responders have responded more often to queries associated with a category of a query, a popularity rating of a query may be affected.

An answerer may receive a notification of a request in various ways. If presence information indicates that an answerer is available an answerer may be more likely to receive a request. A number of available answerer may affect whether an answerer is notified of a request. For example, if a large number of answerers are associated with a first topic and a small number of answerers are associated with a second topic, answerers associated with the first topic may be notified first even if the answerers may not be the most likely and/or best responder based on other criteria.

In an embodiment, an answerer may be notified in a generic manner. Instead of notifying an answerer of a particular question, an answerer may be notified that questions are available on a particular topic. In such an instance an answerer may be provided with questions relating to the topic in an order based on factors such as a number of responses associated with a request, an amount of time since a request was submitted, an expected time until an answer will be provided, etc. This approach may allow a more flexible distribution of requests.

In an embodiment where paid answerers are used to respond to requests, use of a paid answerer or expert may be determined based on various criteria. For example, a question which is associated with a topic which appears frequently in a corpus of queries may be more likely to receive a response from a paid responder than a query associated with a topic which appears rarely in the corpus. Use of a paid answerer may be adjusted based on a user who submits a request. For example, if a user has received answers to queries including similar topics recently, a time interval before a paid answerer is requested to respond may be increased or decreased. If a query is determined to be subjective, a paid answerer may be excluded from responding. If a query is determined to be objective, a larger number of responders may be notified of a request. If a query is determined to be objective a degree of difficulty assigned to the query may be used to determine whether a query will be directed to a paid responder. If a query has a high degree of difficulty and a responder associated with a topic of the query is not available, the query may be routed to a paid responder. If a query is assigned a high degree of difficulty a user submitting a request may be requested to pay for a response.

A rating or ranking of responders may be based on a type of query. For example responders may be ranked based on responses to subjective and/or objective questions. A rating of a responder for subjective queries may be based on an amount of time between a notification and a response. A rating of a responder for subjective queries may be based on a number of times an answer of the responder is viewed or voted up or down. A rating of a responder for a subjective request may be based on a profile of a user submitting a request. If answers of a responder have received positive ratings by a demographic group, the responder may be rated or ranked higher for responding to questions associated with that demographic group.

A rating or ranking of a responder for objective requests may be determined based on verification of answers provided by a responder. For example, if a responder has provided answers to twenty questions, an audit of a sample of five questions may be used to determine a rating of the responder for objective requests. A responder with a high ranking or rating for objective requests may be less likely to receive notifications regarding subjective requests and/or may be more likely to be presented with objective requests than subjective requests.

As previously mentioned, a user or asker may be registered as a responder. In such an instance when a request is submitted, a user submitting a request may be provided with requests associated with topics or categories which may be of interest to the responder. In particular a used may be presented with subjective queries. Subjective queries may be provided to a responder initially in order to encourage interaction. Subjective queries may be provided in an order based on a ranking of the subjective queries. For example queries which are more recent, have a high response rate, have a high rating or ranking for a user, etc. may be provided to a user.

A degree of difficulty of requests provided to a responder may be varied based on a responder history. For example, if a responder has responded to a pre-determined number of subjective requests objective requests relating to topics to which the user has responded may be provided. If a user has responded to a number of objective requests, a degree of difficulty of objective requests may be adjusted based on a success rate associated with the answers provided by a responder. If a user has not recently responded to requests, a degree of difficulty of requests may be adjusted. For example if a user has not recently responded to requests associated with the topic ‘Sports’ a degree of difficulty of requests associated with ‘Sports’ may be adjusted downward.

Responsiveness to user requests may be adjusted based on user actions. If a user responds to requests, receives high ratings, etc., a maximum time to respond to a user request may be adjusted downwards. If a user declines to respond to requests a maximum response time for a user request may be increased. If requests of a user do not receive responses from other users, include unwanted words or phrases, or indicate other unwanted behaviors, a time to respond to a user request and/or a number of responders notified of a request by a user may be adjusted accordingly.

A type of answerer allocated to a request may be determined based on a request. If a request has been assigned a low degree of difficulty or is subjective most common type of responder may be more likely to receive the request. If a request has been reviewed by a number of responders but has not received a response, a user submitting the request may be notified of that status. If a request has been reviewed by a number of responders and has not received a response, a paid answerer may review the request and may assign a degree of difficulty and/or priority to the request. If a paid answerer determines that a request has a high degree of difficulty, a response time for the request may be increased, the request may be deferred until a specialist or expert responder is available, and/or the request may be directed to a paid responder or resource.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 is a flowchart of providing an answer.

FIG. 7 is a flowchart of selecting a resource.

FIG. 8 is a flowchart of ranking a user.

FIG. 9 is a flowchart of ranking a request.

FIG. 10 is a Graphical User Interface (GUI) for submitting a query.

FIG. 11 is a GUI for selecting a topic.

FIG. 12 is a GUI for selecting a query.

FIG. 13 is a GUI for responding to a query.

FIG. 14 is a block diagram of an exemplary system embodiment.

FIG. 15 illustrates a database for requests.

FIG. 16 illustrates a database for users.

FIG. 17 illustrates a database for responders.

FIG. 18 illustrates a database for resources.

FIG. 19 is a flowchart of providing an answer.

FIG. 20 is a flowchart of ranking responders.

FIG. 21 is a GUI for submitting a query.

FIG. 22 is a GUI for selecting a topic.

FIG. 23 is a GUI for selecting a query.

FIG. 24 is a GUI for responding to a query.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server or query distribution system or request processing system receiving the query, a database storing information of queries, search results, searchers, responders, users, resources and other information, a responder system receiving a query and providing a response, and a resource system providing answers and/or other media responsive to a request or query or search request or question.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A determination regarding whether a query is a request for objective or factual information or is a request for subjective or opinion information may be made. A query may be determined to be factual in various ways. Automated analysis may be used to determine if a request is seeking factual information. Content of a request may be used to determine whether the query is factual. A user may indicate whether a query is factual. A user may be provided with a control which indicates whether a query is factual. A query may be determined to be factual based on actions by a responder or other person to whom a query is presented.

A layer of processing may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use. Automated processing of a query which is determined to be factual may be different from automated processing of a query which is determined to be subjective. For example, a match to a subjective query may be less precise than a match to an objective query. Different resources may be used to determine a response to a subjective query than a factual query.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources. An expediter may be used to determine whether a query is subjective or objective. If a query is determined to be subjective an expediter may not be presented with the query.

A third layer of processing of a query may include a human assistant who responds to the query or “searcher”. A searcher or responder or answerer may receive a query, an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. Selection of a responder for a subjective query may be different than selection of a responder for an objective query. A more general matching may be applied for selection of a responder for a subjective query. An objective query may be directed to a responder based on a type and level of knowledge required to respond to the query.

A resource may be selected based on various factors. A resource may be selected based on a group or set of requests. A resource may be selected based on a value associated with a request. A resource may be selected based on a ranking of automated resources for a request. A resource may be selected based on a ranking of responders. A resource may be selected based on a ranking of guides and/or paid responders. A resource may be selected based on topics and/or profile information. A resource selection may be determined as part of a process of responding to a request. Any or all factors and/or criteria may be combined to determine a selection and/or ranking of a resource.

A user may be ranked and/or rated. A user may be ranked based on a topic of a request. A user may be ranked based on a type of a request. A user may be ranked based on a resource selected for a request. A user may be ranked based on a degree of expertise or difficulty associated with a request. A user may be ranked based on answers or responses provided to a user. A ranking of a user may be used for various purposes. A ranking or rating of a user may be used to allocate a resource to a user. Any or all factors and/or criteria may be combined to determine a rating and/or ranking of a user.

A request may be ranked based on content of a request. A request may be ranked based on an expected cost to provide a response, which may include a cost associated with a resource, which may be negative. A request may be ranked based on other requests. A request may be ranked based on temporal information. A request may be ranked based on a resource required to respond to a request. A request may be ranked based on specificity of a request. A request may be ranked based on popularity of a request. A request may be ranked based on a level of expertise required to respond to a request. A request may be ranked based on a success measurement for a request. A request may be ranked based on reuse of a request. Any or all factors may be combined to determine a ranking of a request.

A responder or answerer may be provided with alternative responses to a request. An answerer may be presented with resources and/or snippets extracted from resources based on content of a request. An answerer may be presented with materials from a database of previous questions. An answerer may be allowed to indicate a question is too difficult, off topic, or subjective. A question may be indicated as objective or subjective to an answerer. An answerer may be able to sort objective and subjective questions based on various criteria such as keywords, temporal data, difficulty, etc. An answerer or responder may be selected to perform roles such as expediter, vetter, searcher, generalist, specialist, etc.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services. A resource may be ranked or evaluated based on a type of response which is to be obtained from the resource. A resource may be ranked based on a category, a topic, a keyword, a level of information provided, a type of information such as objective and/or subjective, etc.

Responders may be associated with topics in order to assist in assigning a request to a responder. Topics may be determined based on a corpus of requests, responses, documents, etc. Topics may be restricted to a predetermined number or type of word and/or phrase. A responder may elect to be associated with a topic as a “favorite” or preferred topic, as an accepted topic, and or as a provisional association based on topics associated with queries submitted by a responder and/or answered by a responder. A responder may elect to block a topic.

A rating of a responder for a request may be determined based on various criteria. A number of responders associated with a topic may influence a rating of a responder for a topic. A number of queries submitted regarding a topic may influence a rating or probability that a responder will receive a notification of a request associated with a topic. A time interval between an activity of a responder and receipt of a request may affect a probability or ranking of a responder for a topic and/or a request. Topics assigned to a responder may affect a ranking of a responder for a topic. For example, if a responder is associated with two topics, a ranking for a more frequently submitted topic may be higher than a ranking for a less frequently submitted topic when the responder is more probable to respond to the less frequently submitted topic. A ranking of a responder may be based on a difficulty rating associated with a topic. For example if a difficult query is associated with a topic, a probability that a responder will answer a difficult query may affect a ranking of the responder for the topic.

A group of responders may be notified of a request. For example, a number of highest ranking responders for a topic associated with a query may be notified of the query. A number of responders notified may be determined based on a topic of a request. For example if responders respond to queries associated with a topic more often, a lower number of responders may be notified. Similarly a type of information sought may affect a number of responders notified. For example, if a request is seeking factual information, a number of responders notified may be increased.

A time interval between an action of a responder and a notification may affect whether a responder will be notified of a request. If a responder has submitted a request, a ranking of a responder to receive a notification of a request associated with a topic indicated by the request may be increased. If a responder has been notified of a request a time interval may be required to elapse before another notification is sent to the responder. If a responder does not respond to a notification within a predetermined time interval, a time interval between a most recent notification and a subsequent notification may be increased in a linear, logarithmic, polynomial, exponential, etc. progression.

As used herein, a “request” means a request for information, products, and/or services. A request or search request or query or question may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “responder”, “answerer”, “expediter”, “transcriber”, “specialist” or “generalist”. Guides may be assigned various roles. A guide may be a user. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

As used herein, a “topic” may be any word, phrase or other form of metadata which can be associated with a request based on the request. A topic may include a keyword, category, named entity, classification, a location, a source, etc. A topic may be assigned to a request or query automatically and/or using the assistance of a person such as a guide, user, or responder.

Assignment of topics and ranking of topics may assist in optimizing usage of system elements such as responders, guides, etc. A set of topics may be determined based on a corpus of content, media, etc. Topics may be rated and/or ranked for assignment to responders. A ranking of a topic may be determined based on factors such as frequency of association of a topic with queries, a number of responders associated with a topic, correlation of a topic to other topics, temporal usage of a topic, etc. Topics may be ranked for presentation to a responder. If a user has registered to accept queries regarding a topic, but declines queries associated with the topic, a ranking of the topic for a responder may be adjusted.

A ranking of a topic for a responder may be determined based on factors such as topics currently associated with a responder, statistics of responses to queries associated with topics by the responder, a profile of a responder, a number and response frequency associated with other responders, a frequency of queries associated with a topic, etc.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide, a resource and/or a search system may include conversion of text to speech and speech to text. Any type of media which can be sent and/or received using a communication system may be part of a communication session. A communication session may be conducted using any or all communication services associated with a user, a guide, a resource, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

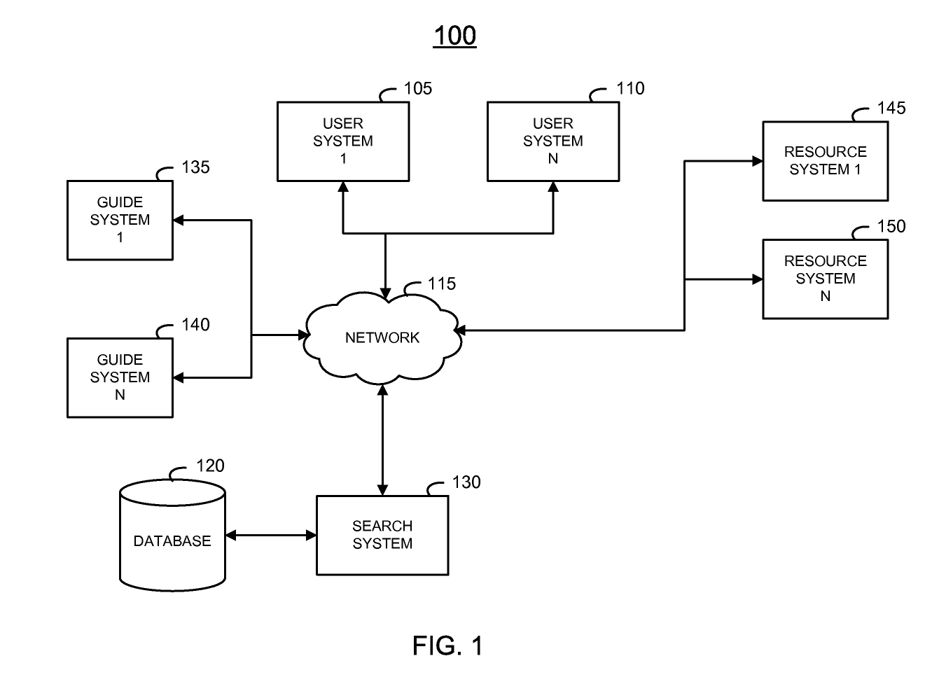

As illustrated in FIG. 1, system 100 includes user systems 105, 110, a network 115 such as the Internet, a search system 130, a database 120, which may comprise various records, guide systems 135, 140, and resource systems 145, 150.

While only a few systems associated with a user, a resource, and a guide or responder are depicted in FIG. 1 it is within the scope of the disclosure for multiple systems for a user, resource, responder and guide to be utilized. In particular it is envisioned that many user, resource and guide systems may be implemented. The search system 130 may be a composed of many components as described further herein.

Any user system (e.g. the user system 105) can be used, to submit a request to the search system 130 and/or receive a result and/or other information. Any user system may receive and/or provide a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the resource systems 145, 150 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, and the resource systems 145, 150. For example, a request can be transmitted from the user system 105 to the search system 130, which may provide information obtained from the database 120, which may include an advertisement to the user system 105. Similarly, a search result from an answerer operating the guide system 135 and/or the resource system 145 might be routed to the search system 130, which might process the search result, formulate a response and provide a message to the user system 105. Any type of communication between users, resources and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150 and the search system 130 may include equipment, software, systems and personnel required to send and/or receive messages between a user system 105, 110, the guide systems 135, 140, the resource systems 145, 150 and/or the search system 130 using the network 115. The database 120 includes information which may allow the search system 130 to establish communication between any or all of the elements of the system 100.

A user system, a guide system, and/or a search system may be a desktop, portable, or tablet PC or Mac®, a mobile phone, a smart phone, a PDA, a server system, a wearable computing device, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, resource systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system, a sponsor system and/or the search system 130. Information such as a keyword, a category, a user profile, a request, a result, etc., may be associated with a user. A user may be required to provide profile information to the search system 130. A user may elect to receive requests from the search system 130 (i.e., a user may elect to act as a responder). Parameters and/or attributes may be associated with a user and/or a resource as will be further described herein below. Information of a user may be stored in the database 120.

A guide or answerer may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, a sponsor system and/or the search system 130.

When a guide registers with the search system 130 the guide may be associated with one or more topics, keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide. A sponsor may designate personnel associated with the sponsor as responders.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

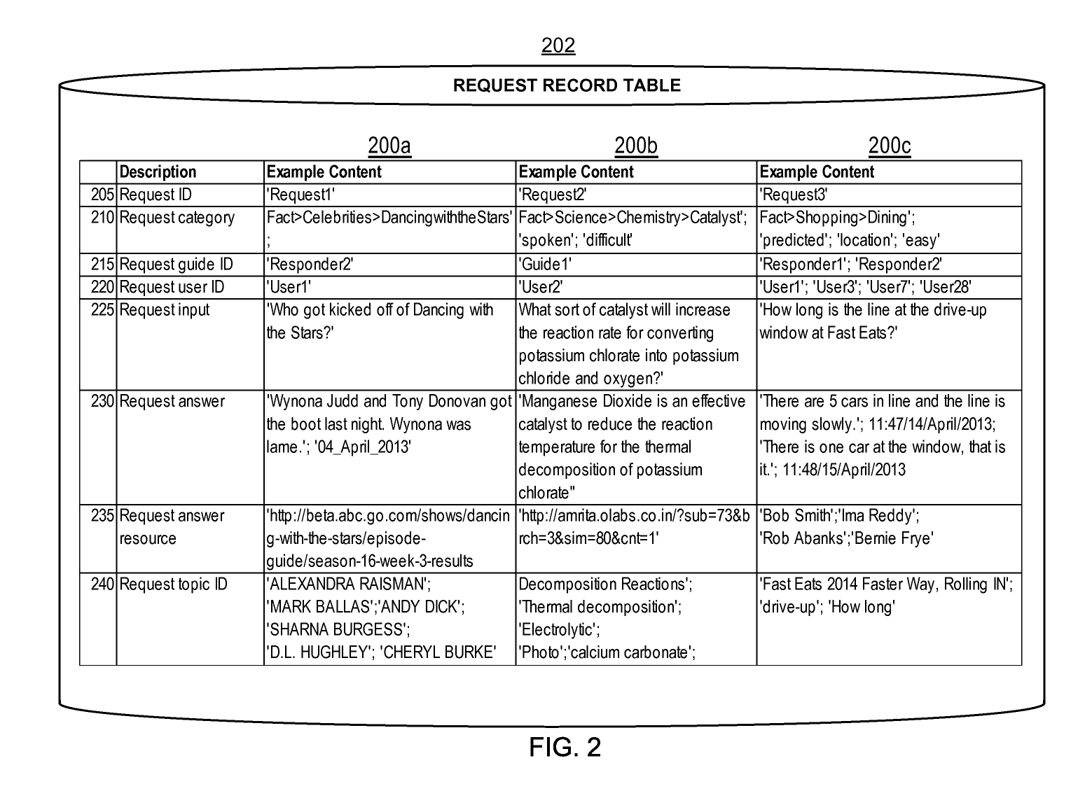

As illustrated in FIG. 2 an exemplary request record table 202 which may comprise a number of request records 200 of which one or more may be associated with or resident in the database 120 (FIG. 1) is provided. While a few request records are depicted in FIG. 2, it is anticipated that many request records may be employed in operation of the embodiments. The request record table 202 may include information of requests which may be processed. The request records 200 may include a request ID field 205, a request category field 210, a request guide ID field 215, a request user ID field 220, a request input field 225, a request answer field 230, a request answer resource field 235 and a request topic ID field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank responders who may be associated with the type of request. Likewise, a category associated with a request may be used to rank requests which may be presented to a guide. A category associated with a request may be determined based on factors such as keywords of a query, a profile of a user, a selection of a guide, a user history, an action of a user, an action of a responder, etc. A category associated with a system taxonomy may be indicated in the request category field 210. A category may be associated with a request automatically and/or using the assistance of a person. Using the example in FIG. 2, ‘Request2’ may be categorized as ‘Fact>Science>Chemistry>Catalyst’, ‘spoken’ and ‘difficult’ as indicated in the request record 200b. This may indicate that a person or item associated with the category ‘Fact>Science>Chemistry>Catalyst’ may have a higher ranking for responding to ‘Request2’. If a request is associated with ‘spoken’ it may indicate that the request was received as a voice query, which may require a transcriber resource. ‘Request2’ may be indicated as ‘difficult’ based on length, content, user and/or topic. A category of a request may be associated with a user submitting the request. Content of a request such as a keyword, named entity, topic, etc. may be used to assign a category or type to a request. A classification as subjective or objective may be required in order that a request may be submitted. A higher degree of difficulty may increase a probability that a paid responder such as a guide or expert responder may be selected to respond to a request.

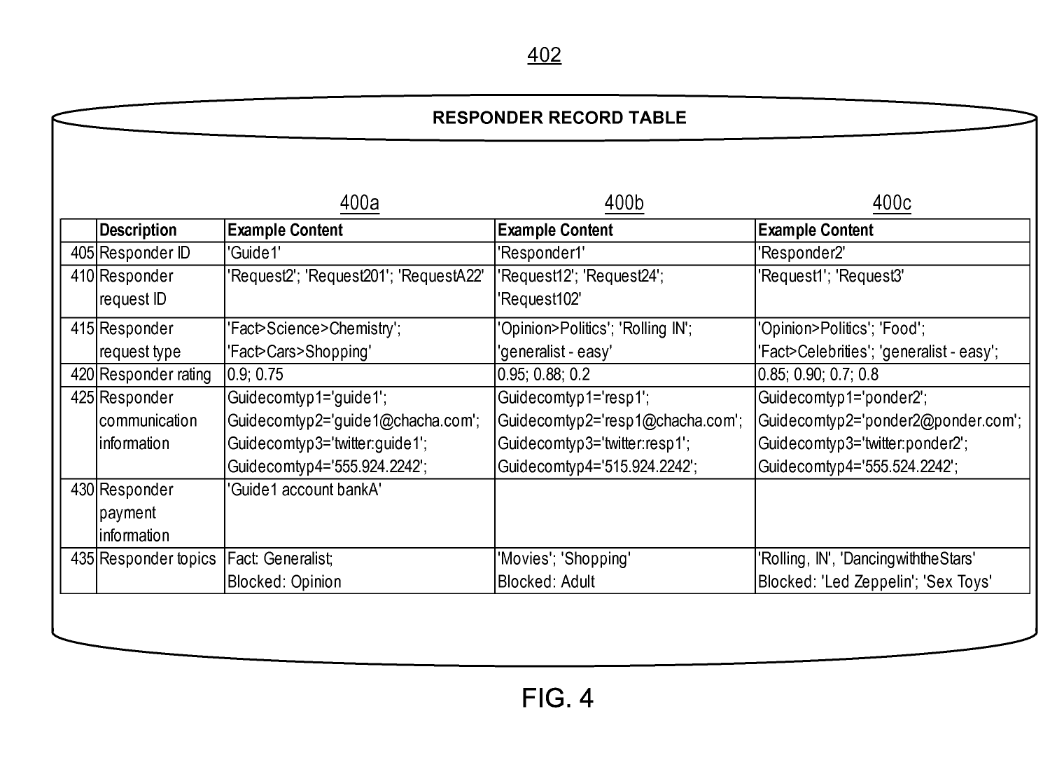

The request guide ID field 215 may include information of a number of guides associated with a request. Content of the request guide ID field 215 may be used to obtain information of a guide using a record such as the responder record 400b (FIG. 4). If a person is selected for a request, elects to receive a request, provides a response to a request, reviews a result of a request and/or completes a request, an identifier of the person may be indicated in the request guide ID field 215. Using the example in FIG. 2, ‘Responder1’ and ‘Responder2’ are associated with ‘Request3’. This may for example indicate that ‘Request3’ has received an automated response from ‘Responded’ and ‘Responder2’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user. For example, the search system 130 (FIG. 1) may provide requests to persons which are not directly related to a user request. The search system 130 may provide a request to a responder based on a selection of the request by a user, a responder, an advertiser, etc. For example the search system may send the query ‘How long is the line at the drive-up window at Fast Eats?’ to an available responder such as ‘Responded’ and ‘Responder2’ located close to ‘Fast Eats’ at approximately the same time each day. A response associated with a responder may be distributed to a number of users. Using the example in FIG. 2, ‘User1’, ‘User3’, ‘User7’ and ‘User28’ are associated with ‘Request3’. This may indicate that a result associated with ‘Request3’ was provided to those users, as indicated by the request record 200c.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘Who got kicked off of Dancing with the Stars?’ is the request input associated with ‘Request1’, as indicated in the request record 200a. In at least one embodiment, the request input field 225 may indicate an original user request, a categorization, and a rewritten user request.

The request answer field 230 may include information of a response associated with a request. Content of the request answer field 230 may be provided to a user responsive to a request. Content of the request answer field 230 may be stored in the database 120 (FIG. 1). Content of the request answer field 230 may be reviewed and/or rated by a user, a guide, an answerer and/or an administrator. As illustrated in FIG. 2, the responses ‘There are 5 cars in line and the line is moving slowly.’, 11:47/14/April/2013 and ‘There is one car at the window, that is it.’, ‘11:48/15/April/2013’ are associated with ‘Request3’ as illustrated in the request record 200c. An answer may include a time stamp, which may indicate when an answer was received. For example, the date and time associated with the answers for ‘Request3’ may indicate that an answer is different on a different date and time and that a newest answer is to be provided. While a text response to a query is used for the purposes of illustration, any type of media may be indicated in the request answer field 230. In at least one embodiment, a text response and a URL associated with a source of the text response may be indicated in the request answer field 230. In at least one embodiment, a responder may select a response, which may cause a URL associated with the response to be inserted in the request answer resource field 235.

The request answer resource field 235 may include information of a resource associated with a request. Content of the request answer resource field 235 may be used for various purposes. A URL associated with a response may be used to determine whether a response is reliable. As illustrated in FIG. 2, a resource may be selected based on a topic of a request. Information of one or more resources associated with a topic of a request may be provided to a responder in order to respond to a request. As illustrated in FIG. 2, information of the resource ‘<<http://beta.abc.go.com/shows/dancing-with-the-stars/episode-guide/season-16-week-3-results>>’ may be provided to ‘Responder2’ when processing ‘Request2’. A resource may be a responder and/or a guide. For example, the responders “Bob Smith’, ‘Ima Reddy’, ‘Rob Abanks’ and ‘Bernie Frye’ might be notified of a ‘Request3’ based on proximity to a location associated with ‘Request3’ as illustrated in the request record 200c.

The request topic ID field 240 may include information of a topic associated with a request. Content of the request topic ID field 240 may be determined based on a query, a response, a resource, a responder, a guide, a user, etc. associated with a request. For example, if a named entity such as ‘Dancing with the Stars’ is included in a request, topics associated with ‘Dancing with the Stars’ which may be extracted from a resource such as ‘<<http://beta.abc.go.com/shows/dancing-with-the-stars/episode-guide/season-16-week-3-results>>’ may be indicated in the request topic ID field 240 as indicated by the request record 200a.

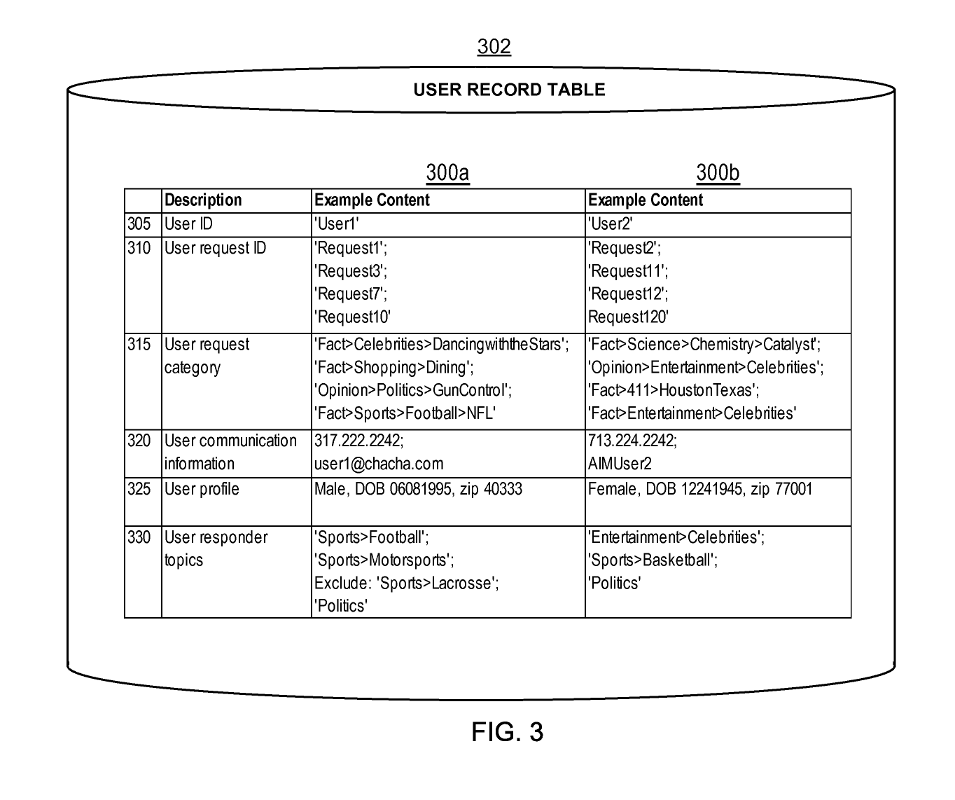

As illustrated in FIG. 3 an exemplary user record table 302, which may comprise a number of user records 300 of which one or more may be associated with or resident in the database 120 (FIG. 1) is provided. The user record table 302 may include information of users. The user records 300 may include a user ID field 305, a user request ID field 310, a user request category field 315, a user communication information field 320, a user profile field 325, and a user responder topics field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’, ‘Request12’ and ‘Request120’ are associated with ‘User2’ as indicated in the user record 300b. This may indicate that ‘User2’ has submitted ‘Request2’, ‘Request11’, ‘Request12’and ‘Request120’.

The user request category field 315 may include information regarding a category, type, etc., associated with a user request. For example, if a request is directed to a type of processing or a category, etc., a type, topic, and/or category associated with the processing may be indicated in the user request category field 315. In at least one embodiment, the user request ID field 310 and the user request category field 315 are linked by for example a pointer. In at least one embodiment, a user may be restricted to submitting questions which are subjective, objective, etc. A user may be restricted to accepting subjective, objective, etc., requests. Content of the user request category field 315 may be used to determine categories and/or topics of queries which may be directed to a guide, a responder, a user and/or a resource. Content of the user request category field 315 may be used to rank resources, guides, advertisements, etc. and may affect a probability that an item will be presented to a user, guide or responder.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. An answer might be modified based on geographic, demographic, etc., profile information of a user. A responder, guide and/or resource might have a different rating and/or ranking based on profile information of a user.

The user responder topics field 330 may include information of topics associated with a user for which the user may be selected as a responder. The user responder topics field 330 may include topics for which a user has elected to receive questions and/or topics for which a user has requested not to receive questions. Content of the user responder topics field 330 may be used to rate a user for a request. As illustrated in FIG. 3, a query associated with ‘Politics’ or ‘Sports’ might be directed to ‘User1’ and ‘User2’, but if the query is associated with ‘Sports>Lacrosse’ ‘User1’ would not receive the query. A user may elect to receive subjective and/or objective requests associated with a category or topic.

As illustrated in FIG. 4 an exemplary responder record table 402 which may comprise a number of responder records 400 of which one or more may be associated with or resident in the database 120 (FIG. 1) is provided. The responder record table 402 (FIG. 4) may include information of responders. The responder records 400 may include a responder ID field 405, a responder request ID field 410, a responder request type field 415, a responder rating field 420, a responder communication information field 425, a responder payment information field 430, and a responder topic field 435.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. In at least one embodiment, a pseudonym selected by a responder may be indicated in the responder ID field 405. A first and last name of a responder may be indicated in the responder ID field 405. Using the example in FIG. 4, ‘Guide1’ is the responder ID associated with the responder record 400a.

The responder request ID field 410 may include information of a number of requests associated with a responder. Content of the responder request ID field 410 may be used to obtain information of a request. For example, if a user request has been determined to require a number of requests to be performed, the search system 130 (FIG. 1) may assign a unique ID to the requests and may distribute information of the requests to responders. Using the example in FIG. 4, Vettert is associated with ‘Request12’, ‘Request24’ and ‘Request102’ as indicated in the responder record 400b. This may indicate that ‘Vetter1’ has responded to those requests by for example classifying, transcribing, clarifying, etc.

The responder request type field 415 may include information of a number of types of requests which may be processed by a responder. For example, a category, topic and/or keyword associated with a request, a type of request, temporal information associated with a request, etc., which may be used to determine if a responder is to be presented with a request may be indicated in the responder request type field 415. In at least one embodiment, a responder may be assigned to a particular type of request as part of a registration process. A responder may select a type of request which the responder may receive. A responder may be required to pass a test in order to be associated with a type of request. For example if a responder is to provide responses to factual queries, an assessment of a responder's knowledge of a topic may be performed. A responder may be assigned to a role such as vetter, expediter, searcher, etc., which may be indicated in the responder request type field 415. A request indicating a keyword may be directed to a responder. Using the example in FIG. 4, ‘Responder1’ is associated with ‘Opinion>Politics’, ‘Rolling IN’ and ‘generalist—easy’ as indicated in the responder record 400c. This may for example indicate that ‘Responder1’ may be presented with and/or selected to respond to requests indicating those classifications, topics, etc. For example, ‘Responder1’ might be willing to accept general queries which are classified as ‘easy’.

The responder rating field 420 may include information of a number of ratings associated with a responder. For example, quality, speed, peer review, response time, response frequency, etc., may be used to determine a rating of a responder. A rating of a responder may be used for purposes such as determining compensation for the responder, selecting a responder to respond to a request, matching a request to a responder, etc. In at least one embodiment, the responder request type field 415 and the responder rating field 420 may be linked by, for example, a pointer. Using the example in FIG. 4, ‘Responder1’ and ‘Responder2’ are associated with the type ‘Opinion>Politics’ and ‘generalist—easy’. This may indicate that ‘Responder1’ might be more likely or probable to receive a request associated with ‘Opinion>Politics’ while ‘Responder2’ might have a higher probability to be selected for a query associated with a topic for which no responder is available which is classified as ‘easy’ based on the ratings indicated in the responder rating field 420.

The responder communication information field 425 may include information of a number of communication services associated with a responder. For example, a user name and password, an email address, an IM credential, a phone number, a web page, a physical address, etc., may be indicated in the responder communication information field 425. Using the example illustrated in FIG. 4, ‘Guide1’ is associated with the login ID ‘guide1’, the email ‘guide1@chacha.com’, the Twitter account ‘twitter.guide1’, and the phone number ‘555.924.2242’. This may indicate that ‘Guide1’ may be contacted using the associated communication services.

The responder payment information field 430 may include information of a payment method associated with a responder. For example, banking information, a PayPal® account, a Western Union® account, etc., may be indicated in the responder payment information field 430. Content of the responder payment information field 430 may be used to provide compensation to a responder. For example, payment may be made by Automated Clearing House (ACH), wire transfer, etc., using information indicated in the responder payment information field 430. If a responder is not compensated, the responder payment information field 430 may be blank. As illustrated in FIG. 4, ‘Guide1 account bankA’ is associated with ‘Guide1’ as indicated by the responder record 400a.

The responder topic field 435 may include information on topics which may be associated with a responder. The information associated with the responder topics may be topics for which the responder has agreed to accept requests or topics which the responder has blocked and thus will not be offered requests associated with the topics. As illustrated in FIG. 4 “Movies’ and ‘Shopping’ are topics for which ‘Responder1’ may receive notifications and blocked topics for which ‘Responder1’ may not receive notifications include ‘Adult’. A responder may be ranked based upon topics associated with a responder. A higher ranking for a topic may increase a probability that a responder will be notified of a request. Topics associated with a responder may be ranked. A higher ranking topic may affect a probability that a responder may be notified of a request associated with a topic. For example, if a responder is associated with a high ranking topic, the responder may be more likely to be notified or selected or chosen to respond to a request associated with the high ranking topic or keyword. A resource may be associated with a responder. For example, if a responder has access to a particular resource which is not available to all responders, a ranking of a responder for a topic associated with a resource may be increased.

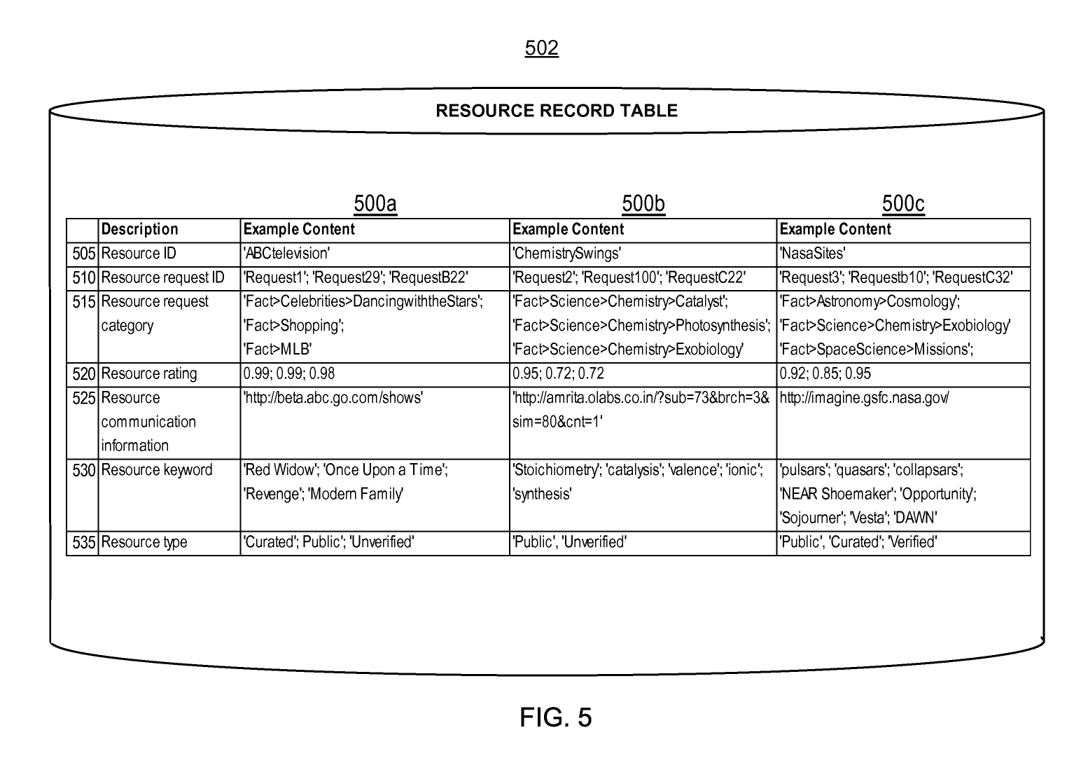

As illustrated in FIG. 5 an exemplary resource record table 502 which may comprise a number of resource records 500 of which one or more may be associated with or resident in the database 120 (FIG. 1) is provided. The resource record table 502 (FIG. 5) may include information of resources. The resource records 500 may include a resource ID field 505, a resource request ID field 510, a resource request category field 515, a resource rating field 520, a resource communication information field 525, a resource keyword field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘ABCtelevision’ is the resource ID associated with the resource record 500a.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource ‘ChemistrySwings’ as indicated in the resource record 500b. This may indicate that ‘ChemistrySwings’ has been utilized to respond to ‘Request2’, ‘Request100’ and ‘RequestC22’.

The resource request category field 515 may include information of a number of categories of requests which may be processed by a resource. For example, a category and/or keyword associated with a request, a type of request, profile, etc., which may be used to determine if a resource and/or a result obtained from a resource is to be presented to a responder for a request may be indicated in the resource request category field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘NASASites’ is associated with the category ‘Fact>Astronomy>Cosmology’, ‘Fact>SpaceScience>Missions’ and ‘Fact>Science>Chemistry>Exobiology’ as indicated by the resource record 500c.

The resource rating field 520 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher, responder, or guide, to rank a response associated with a resource, etc. In at least one embodiment, the resource request category field 515 and the resource rating field 520 may be linked by, for example, a pointer. Using the example in FIG. 5, ‘ChemistrySwings’ has a rating of ‘0.72’ associated with ‘Fact>Science>Chemistry>Exobiology’, and ‘NASASites’ has a rating ‘0.95’, associated with ‘Fact>Science>Chemistry>Exobiology’ which may for example indicate that ‘NASASites’ is more likely to produce an acceptable response for that category. A resource may have a rating corresponding to various categories, topics, types of information, types of tasks, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<http://imagine.gsfc.nasa.gov/>> is associated with ‘NASASites’. This may indicate that a query associated with ‘Fact>Science>Chemistry>Exobiology’ may be submitted to a search facility associated with that URL by for example an API.

The resource keyword field 530 may include information of a number of keywords associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, responder, vetter, etc. In at least one embodiment, keywords included in requests for which a resource has provided an answer may be more highly ranked for a category associated with the query and the resource. Content of the resource keyword field 535 may be obtained based on analysis of media associated with a resource. For example, text, metadata, images, etc. which are associated with a resource may be analyzed to identify, rate, rank, categorize, etc. keywords and/or topics which may be associated with a responder.

The resource type field 535 may include information of a number of types or characteristics associated with a resource. A type may include an indication of an access right, a commercial arrangement, a preference, quality of content, source of content, etc. A searcher may elect to associate a resource with a type. A system administrator may associate a type with a resource. A provider of a resource may designate a type associated with the resource as part of a registration process. Using the example in FIG. 5, ‘ABCtelevision’ is an ‘Unverified’, ‘Public’, ‘Curated’ resource. This may indicate that content of the resource is controlled, that the resource is accessible to the general public, and that the content of the resource is not verified to be correct.

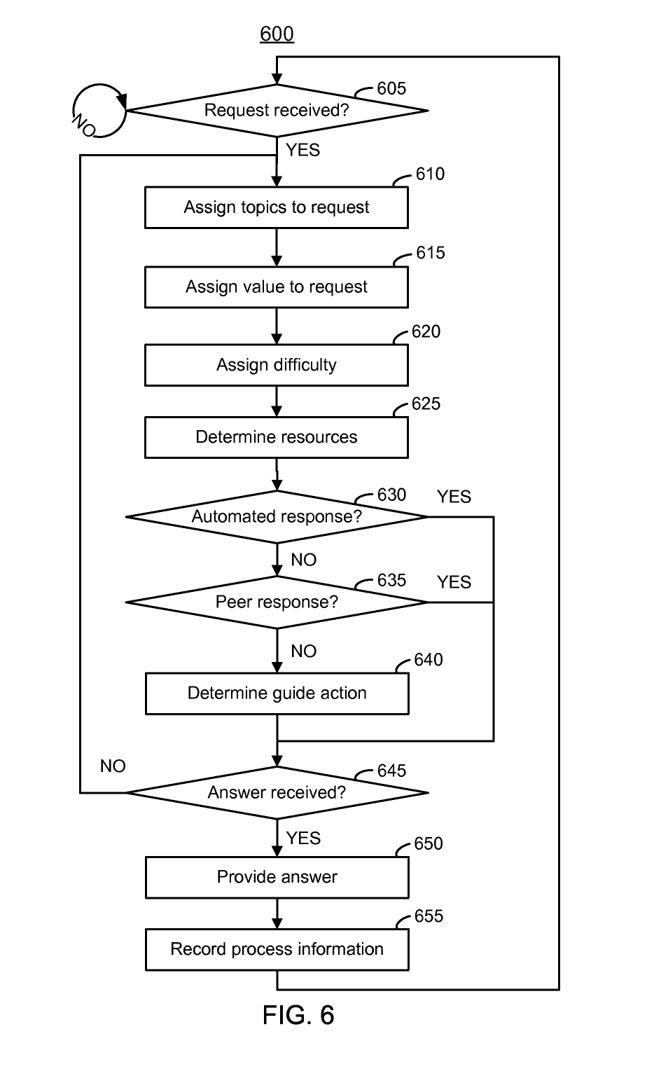

As illustrated in FIG. 6, a process 600 for providing an answer is provided. The process 600 may be performed in whole or in part by any suitable element of the system 100 (FIG. 1). In at least one embodiment, the process 600 is operative on a server associated with the search system 130. A request may be a request for an automated answer, a human assisted answer and/or a combination thereof.

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. A request may be received based on chronological information. For example, if it is close to breakfast time in a particular location, a request to know the length of a waiting queue at a restaurant may be generated which may be directed to persons associated with the restaurant. If a message is received at a server associated with the search system 130, it may be determined that a request is received.

In operation 610 topics are assigned to a request. Topics may be assigned to a request in various ways. Content of a request may be used to associate a topic with a request. For example, keywords of a request may be used to identify a topics associated with a request, a pronoun reference of a request may be resolved to a named entity which is used to select a topic associated with a request. A profile of a user associated with a request may be used to associate a topic with a request. For example, a demographic, geographic, topical, etc. parameter of a user profile may be used to associate a topic with a request. Topics assigned to a request may be modified based on an action of a guider and/or responder. Control is passed to operation 615 and process 600 continues.

In operation 615, a value is assigned to a request. A value or benefit assigned to a request may be based on various factors. For example, if a request is from a highly ranked user a value associated with a request may be increased. If a request is associated with a popular topic, a value associated with a request may be increased. If a probability that a request will be reused is low, a value associated with a request may be reduced. If compensation is associated with a response, a value associated with a request may be increased. If a request has been pending for a time period, a value associated with a request may be modified based on a time interval. Any suitable criteria may be used to assign a value to a request. Control is passed to operation 620 and process 600 continues.

In operation 620, a difficulty is assigned to a request. A difficulty assigned to a request may be determined based on various factors. For example, a responder or guide may indicate a difficulty associated with a request. Temporal information may be used to assign a difficulty to a request. For example if a number of responders have viewed and/or been notified of a request and declined to respond a difficulty associated with a request may be increased. A topic and/or length of a request may affect a difficulty assigned to a request. For example, if historical queries related to a topic have been found to be difficult, a query associated with a topic may be assigned a high degree of difficulty. Any suitable criteria may be used to assign a difficulty to a request. Control is passed to operation 625 and process 600 continues.

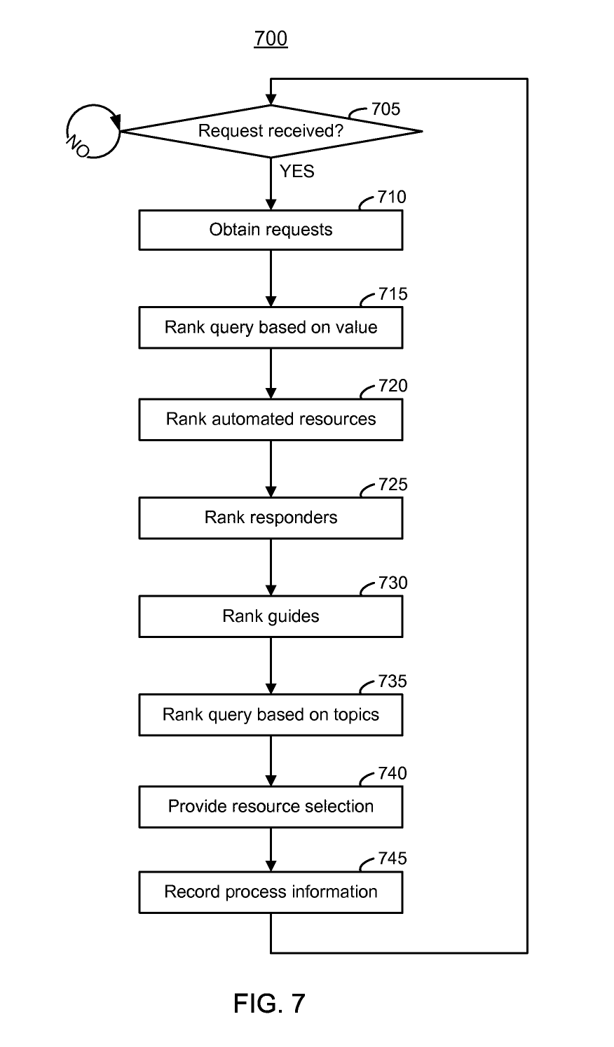

In operation 625, resources are determined. Resources may be determined based on factors such as a rating or ranking of a query, a user, a resource, a guide, a responder, etc. A process for determining resources is further described with respect to FIG. 7. Control is passed to operation 630 and process 600 continues.

In operation 630, a determination is made as to whether an automated response is possible. If it is determined in operation 630 that an automated response is not possible, control is passed to operation 635 and process 600 continues. If it is determined in operation 630 that an automated response is possible, control is passed to operation 645 and process 600 continues.

The determination in operation 630 may be made using various criteria. If a match is found to an existing response and/or an automated resource, it may be determined that an automated response is possible. If a responder indicates that an automated response is possible, it may be determined that an automated response is possible. If it is determined that a request requires access to a non-public resource for which a user is not authorized, it may be determined that an automated response is not possible. Any suitable criteria may be used to determine whether an automated response is possible.

In operation 635, a determination is made as to whether a peer response is possible. If it is determined in operation 635 that a peer response is not possible, control is passed to operation 640 and process 600 continues. If it is determined in operation 635 that a peer response is possible, control is passed to operation 645 and process 600 continues.

The determination in operation 635 may be made using various criteria. For example, if a request is assigned a low degree of difficulty it may be determined that a peer response is possible. If a request is seeking subjective information it may be determined that a peer response is possible. If a responder indicates that a peer response is not possible, it may be determined that a peer response is not possible. If a request has been pending for a period of time or if a responder associated with a topic of a query or if a responder of a sufficient rating or ranking for a request is not available it may be determined that a peer response is not possible. Any suitable criteria may be used to determine whether a peer response is possible.

In operation 640, a guide action is determined. For example, a guide may provide a response to a request. A guide may reclassify a request. A guide may assign a difficulty to a request. A guide may indicate a rating of a user. A guide may indicate a rating of a response. A guide may indicate a resource. Control is passed to operation 645 and process 600 continues.

In operation 645, a determination is made as to whether an answer is received. If it is determined in operation 635 that an answer is received, control is passed to operation 650 and process 600 continues. If it is determined in operation 645 that an answer is received, control is passed to operation 610 and process 600 continues.

The determination in operation 645 may be made using various criteria. If an automatic response is received, it may be determined that an answer is received. If a peer response is received it may be determined that an answer is received. If a guided answer is received it may be determined that an answer is received. If a time period has elapsed it may be determined that an answer is received. If a criterion for selection of a response, resource, etc., is modified, it may be determined that an answer is not received. Any suitable criteria may be used to determine whether an answer is received.

In operation 650 an answer is provided. An answer may be provided to a user, may be recorded in a database, may be provided to a responder, etc. An answer may be provided using any communication service and/or device associated with a requester. Control is passed to operation 655 and process 600 continues.

In operation 655, process information is recorded. Information of a request, an answer, a category, a topic, a keyword, a resource, a user, a guide, a responder, a rating, a ranking, etc. may be recorded. In at least one embodiment, process information is recorded in the database 120 (FIG. 1). Control is passed to operation 605 and process 600 continues.

As illustrated in FIG. 7, a process 700 for selecting resources for a request is provided. The process 700 may be performed in whole or in part by any suitable element of the system 100 (FIG. 1). In at least one embodiment, the process 700 is operative on a server associated with the search system 130. The process 700 may operate in conjunction with the process 600 (FIG. 6)

In operation 705 (FIG. 7) a determination is made as to whether a request is received. If it is determined in operation 705 that a request is not received, control remains at operation 705 and process 700 continues. If it is determined in operation 705 that a request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 710 requests are obtained. For example, a group of active requests which require allocation of resources may be obtained. Requests may be obtained which are not linked to a user. Requests may be obtained associated with a category, topic, etc. Control is passed to operation 715 and process 700 continues.

In operation 715 a query is ranked based on value. A value associated with a query may be determined on any suitable basis. For example, popularity, compensation, time, users, responders, type, etc., may be used to assign a value to a request or query. Control is passed to operation 720 and process 700 continues.

In operation 720 automated resources are ranked. For example an automated resource which is related to a topic of a request may be ranked highly, or an automated resource associated with a location linked with a request may be ranked highly. Frequency of use of an automated resource may be used to rank automated resources. User and/or guide selection of a response provided by an automated resource, including statistical data of actions by responders and/or guides may be used to rank automated resources. A match to a request may be used to rank an automated resource. Control is passed to operation 725 and process 700 continues.

In operation 725 responders are ranked. For example success rates associated with a topic may be used to rank a responder. A frequency of response and/or time to respond to a request may be used to rank a responder. A number of times a user elects to communicate with a responder may be used to rank a responder. For example, if a user elects to initiate a conversation with a responder, a ranking of a responder may be increased. A responder may be ranked based on a frequency of use of a topic associated with a responder. For example if a responder is associated with topics which do not appear often in user requests, a ranking of a responder may be reduced. If a responder is registered as a generalist and a request is associated with a specific topic, a ranking of a responder may be reduced. Control is passed to 730 and process 700 continues.

In operation 730 guides are ranked. A guide may be ranked based on compensation associated with a guide response. A guide may be ranked based on whether a guide accepts requests associated with topics which are not associated with responders. A guide may be ranked based on a skill associated with a guide such as translation, transcription, etc. Guides may be ranked on any suitable basis. Control is passed to operation 735 and process 700 continues.

In operation 735 queries are ranked based on topics. Queries which are associated with topics which are associated with responders may be ranked higher. Queries which are associated with topics which appear infrequently may be ranked or rated lower. Queries which are factual may be rated lower. Queries which match an automated response may be ranked higher. Queries may be ranked on any suitable basis. Control is passed to operation 740 and process 700 continues.

In operation 740 a resource selection is provided. Resources may be provided in various ways. For example, indicators of resources which match a query best may be provided to a responder selected to respond to the query. A list of responders to be notified to respond to a request may be provided to a notification server. A list of requests and guides may be provided to a query server which may distribute queries and/or resources to guides. Queries may be directed to automated resources based on a probability that an automated resource will provide a suitable response to a query. Control is passed to operation 745 and process 700 continues.

In operation 745, process information is recorded. Information of a user, a guide, a responder, a rating, a ranking, etc. may be recorded. A rating, ranking and/or content of a topic, response, resource, responder and/or request may be recorded. In at least one embodiment, process information is recorded in the database 120 (FIG. 1).

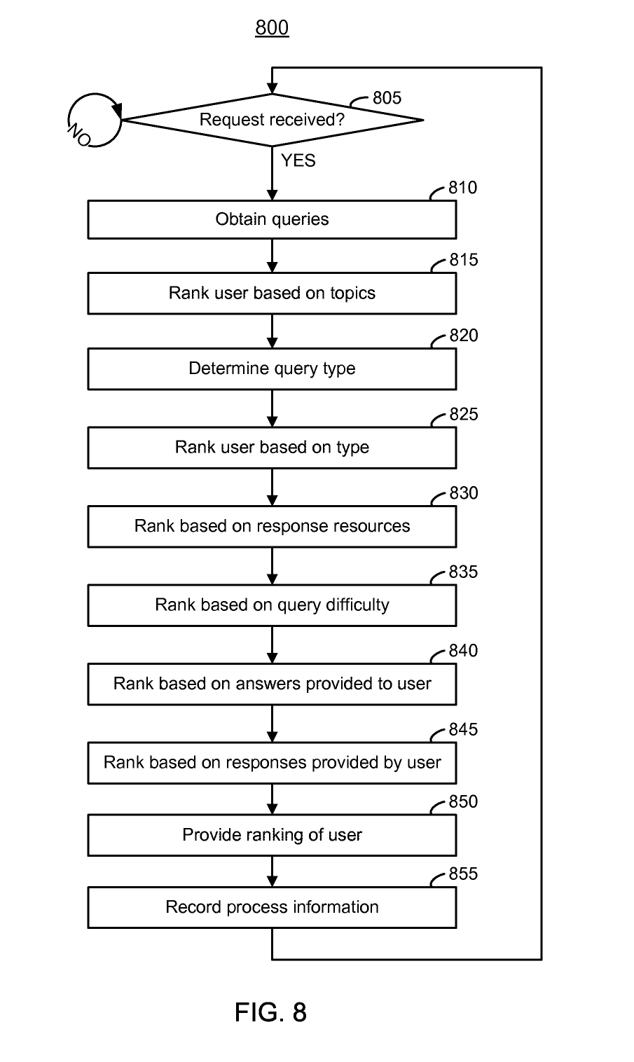

A process 800 for ranking a user is illustrated in FIG. 8. The process 800 may be performed in whole or in part by any suitable element of the system 100 (FIG. 1). In at least one embodiment, the process 800 is operative on a server associated with the search system 130.

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 will continue.

In operation 810 user queries are obtained. User queries may include queries by a plurality of users. A query of a user may be selected based on a number of types, topics, categories, etc. Control is passed to operation 815 and process 800 will continue.

In operation 815 a user is ranked based on topics. For example if a user submits request which are associated with popular topics a ranking of a user may be increased. If a user submits queries which are not associated with topics selected by responders, a ranking of a user may be decreased. If a user responds to requests associated with topics for which a user has submitted requests, a ranking of a user may be adjusted. Control is passed to operation 820 and process 800 continues.

In operation 820 a type associated with a query is determined. A type may be determined based on responses associated with queries. A type may be determined based on historical information associated with a request. For example if a number of responses is associated with a request, it may be determined that a request is seeking subjective information. If a request receives an automated response, a type associated with the response may be associated with a request. Control is passed to operation 825 and process 800 will continue.

In operation 825 a user is ranked based on type. For example, if a user submits a large number of subjective queries a ranking of a user for subjective queries may be increased. If a user submits a number of queries which are factual and require a response of a guide a ranking of a user for factual queries may be decreased. If a user submits queries which receive automated responses a ranking of a user may increase. If a user submits queries which require voice transcription, a ranking of a user may decrease. Control is passed to operation 830 and process 800 continues.

In operation 830 a user is ranked based on response resources. If a user query requires that a number of responders are notified of a request, a ranking of a user may be reduced. If a user query is frequently answered by a peer answerer a ranking of a user may increase. Control is passed to operation 835 and process 800 continues.

In operation 835 a user is ranked based on query difficulty. For example if a user submits a query which requires a long time to receive a response, a ranking of a user may be reduced. If a user submits a query which receives a rapid response from peer responders, a ranking or rating of a user may increase. Control is passed to operation 840 and process 800 continues.

In operation 840 a user is ranked based on responses provided to a user. If a user has received a relatively large percentage or number of answers from guides a ranking of a user may be reduced. If a user has received a relatively large percentage of number of answers from peer answerers and/or automation a ranking of a user may be increased. If a user has received a large number of responses compared to other users, a ranking of the user may be decreased. Control is passed to operation 845 and process 800 continues.

In operation 845 a user is ranked based on responses provided by a user. If a user provides a number of responses to requests, a ranking of a user may be increased. If a user does not respond to notifications of requests, a ranking of a user may be decreased. If responses of a user are rejected, a rating of a user may be decreased. Control is passed to operation 850 and process 800 continues.

In operation 850 a ranking of a user is provided. A list of users in order of ranking may be provided via an API, a GUI, etc. A ranking of a user may be provided when a resource is being selected. A ranking of a user may be used to determine an order of presentation of requests. A ranking of a user may be based on any combination of factors applied in any order. Control is passed to operation 855 and process 800 continues.

In operation 855 process information is recorded. A ranking of users may be recorded. A ranking of a user associated with a particular group of queries may be stored. In at least one embodiment, process information is recorded in the database 120 (FIG. 1). Control is passed to operation 805 and process 800 continues.

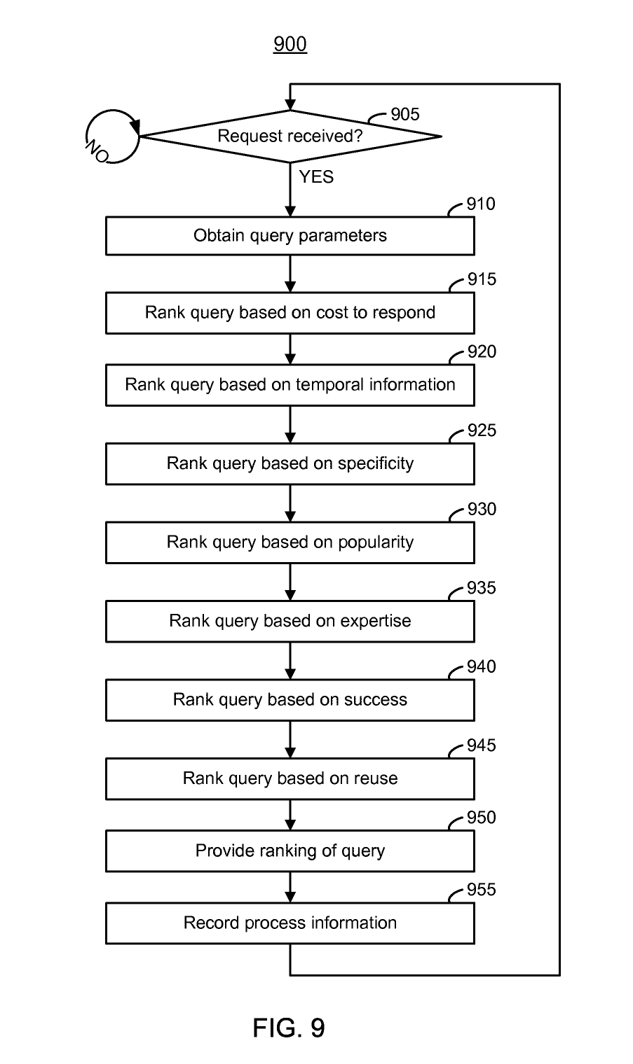

A process 900 for ranking a query is illustrated in FIG. 9. The process 900 may be performed in whole or in part by any suitable element of the system 100 (FIG. 1). In at least one embodiment, the process 900 is operative on a server associated with the search system 130.

In operation 905 (FIG. 9) a determination is made as to whether a request is received. If it is determined in operation 905 that a request is not received, control remains at operation 905 and process 900 continues. If it is determined in operation 905 that a request is received, control is passed to operation 910 and process 900 will continue.

In operation 910 query parameters are obtained. A profile, a location, topics, user, a guide, a responder, a resource, temporal information, etc., associated with a query may be obtained. Control is passed to operation 915 and process 900 will continue.

In operation 915 a query is ranked based on cost to respond. A cost to respond to a request may be based on a topic, a resource, resource availability, etc. associated with a query. Control is passed to operation 920 and process 900 continues.

In operation 920 a query is ranked based on temporal information. For example, a more recent query may be ranked higher than an older request. Control is passed to operation 925 and process 900 will continue.

In operation 925 a query is ranked based on specificity. If a query is associated with a topic which is found only in one category or which is not correlated to other topics, a specificity ranking of a query may be increased. If a query is determined to be unambiguous a specificity ranking of a query may be increased. If a query is seeking subjective information, a specificity ranking of a query may be decreased. Control is passed to operation 930 and process 900 continues.

In operation 930 a query is ranked based on popularity. If a query is associated with a topic for which a higher proportion of responders accept queries, a popularity ranking of a query may increase. If a query is associated with a topic which appears in a higher proportion of user requests, a popularity ranking of a request may increase. Control is passed to operation 935 and process 900 continues.

In operation 935 a query is ranked based on expertise. If a query is answered by an expert, an expertise ranking of a query and/or topics associated with a query may be increased. If a query is labeled as subjective an expertise ranking associated with a request may be decreased. If a responder declines to answer a request associated with a topic of a responder, an expertise ranking of a request may increase. If a response to a request is obtained from a resource associated with a particular level of expertise, an expertise ranking of a request may be adjusted accordingly. Control is passed to operation 940 and process 900 continues.

In operation 940 a query is ranked based on success. If a query does not receive a response, a success ranking of a request may be decreased. If a large number of responders are notified in order to obtain a response, a success ranking of a request may be reduced. If a responder replies quickly, or if an automated response is accepted, a success ranking of a request may be increased. Control is passed to operation 945 and process 900 continues.

In operation 945 a request is ranked based on reuse. For example if a query is factual and is directed to a popular topic, a reuse ranking of a request may be increased. If a query is presented as a suggested query and a user accepts the query reuse ranking of a query may be increased. Control is passed to operation 940 and process 900 continues.

In operation 950 a ranking of a query is provided. A list of queries in order of ranking may be provided via an API, a GUI, etc. A ranking of a query may be provided when a resource is being selected. A ranking of a query may be used to determine an order of presentation of requests. A ranking of a query may be based on any combination of factors applied in any order. Control is passed to operation 955 and process 900 continues.

In operation 955 process information is recorded. A ranking of a query may be recorded. A ranking of a query associated with a particular group of queries may be stored. In at least one embodiment, process information is recorded in the database 120 (FIG. 1). Control is passed to operation 905 and process 900 continues.

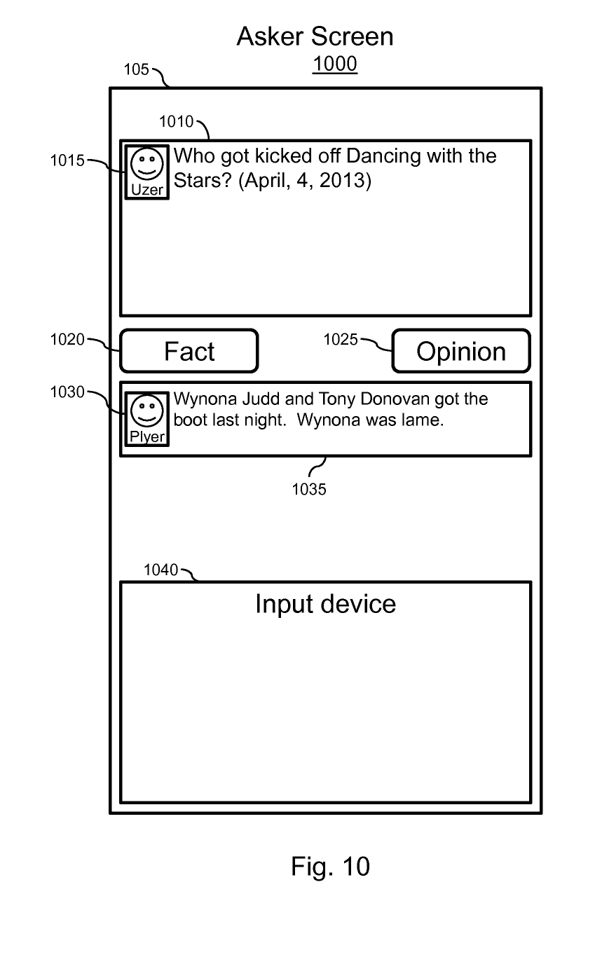

As illustrated in FIG. 10 an exemplary GUI 1000 for submitting a request is provided. The query submission GUI 1000 may be provided to a user. The GUI 1000 may be presented using a system such as the user system 105 (FIG. 1). The GUI 1000 may be used to submit any type of request. The GUI 1000 may include a query entry area 1010, a user identifier 1015, a factual query indicator 1020, an opinion query indicator 1025, a responder indicator 1030, a response indicator 1035, and a user input control 1040.

The request entry area 1010 may be used to indicate information of a request. The user indicator 1015 may be used to indicate information of a user submitting a request. The factual query indicator 1020 may be used to indicate that a request is a request for factual information. Activation of the factual query indicator 1020 may cause a request indicated in the request entry area 1010 to be associated with the type ‘Fact’. Activation of the opinion query indicator 1025 may indicate that a request is a request for subjective information. The responder indicator 1030 may be used to indicate a source of a response. The response indicator 1035 may be used to indicate a response associated with a request indicated in the request indicator 1010. The user input control 1040 may be used to submit a request. While a keypad is used for purposes of illustration, any user input device which is well known in the art may be used to implement the user input control 1040.

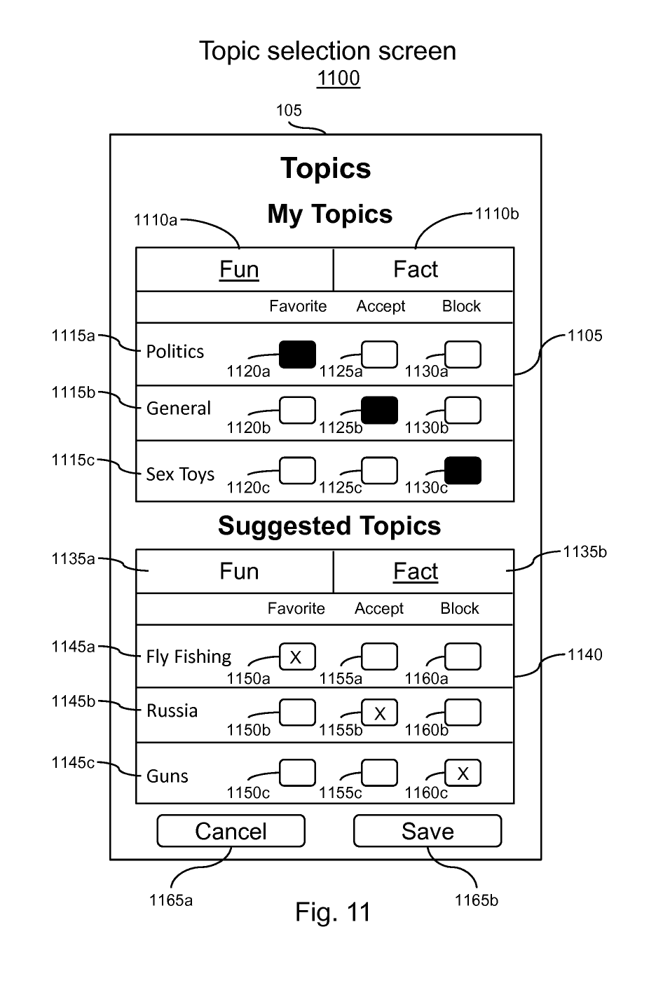

An exemplary GUI 1100 for registering topics is illustrated in FIG. 11. The GUI 1100 may be provided to an answerer via a device such as the user system 110 (FIG. 1) or the guide system 135 to register for and manage topics. The GUI 1100 may include a registered topic area 1105, registered topic type indicators 1110, registered topic indicators 1115, registered favorite indicators 1120, registered acceptance indicators 1125, registered blocking indicators 1130, suggested topic area 1140, suggested topic type indicators 1135, suggested topic indicators 1145, suggested favorite indicators 1150, suggested acceptance indicators 1155, suggested blocking indicators 1160, and action controls 1165.

The registered topic area 1105 may include information of topics for which a responder has elected to receive requests and/or block requests. The registered topic type indicators 1110 may be used to select a type associated with a registered topic. Activation of the ‘Fun’ registered topic indicator 1110a may cause information of topics associated with opinion type queries to be provided. Activation of the ‘Fact’ registered topic indicator 1110b may cause information of topics associated with objective queries to be provided. The ‘Fun’ registered topic type indicator 1110a is active as indicated by the underline in FIG. 11. The registered topic indicators 1115 may be used to indicate information regarding a registered topic. For example, the ‘Politics’ registered topic indicator 1115a may be used to indicate registration status of a responder for ‘Politics’. The registered favorite indicators 1120 may be used to indicate whether a user has indicated that a topic is a favorite. For example the filled rectangle in the registered favorite indicator 1120a may indicate that ‘Politics’ is a favorite, while the unfilled rectangles in the registered favorite indicators 1120b, c may indicate ‘General’ and ‘Sex Toys’ are not favorites. Activation of a registered favorite indicator may toggle the status of a registered favorite indicator. The registered acceptance indicators 1125 may be used to indicate that request associated with a topic will be accepted. For example the filled rectangle in the registered acceptance indicator 1125a may indicate that requests associated with ‘General’ will be accepted. The registered blocking indicators 1130 may be used to indicate that requests associated with a topic are to be blocked. For example, the filled rectangle in the registered blockade indicator 1130c may indicate that requests associated with ‘Sex Toys’ are to be blocked. A user may be able to sort topics in the registered topic area 1105 based on whether a topic is a favorite, accepted, or blocked. A search facility may be provided for a user to locate a registered topic. A user may navigate through content of the registered topic area 1105 using typical navigation features.

The suggested topic area 1140 may include information of topics which are recommended for a responder. The suggested topic type indicators 1135 may be used to select a type associated with a suggested topic. Activation of the ‘Fun’ suggested topic indicator 1135a may cause information of suggested topics associated with opinion type queries to be provided. Activation of the ‘Fact’ suggested topic indicator 1135b may cause information of topics associated with objective queries to be provided. The ‘Fun’ suggested topic type indicator 1135a is active as indicated by the underline in FIG. 11. The suggested topic indicators 1145 may be used to indicate information regarding a suggested topic. For example, the ‘Fly Fishing’ suggested topic indicator 1145a may be used to indicate a type of registration recommended to a responder for ‘Fly Fishing’. The suggested favorite indicators 1150 may be used to indicate that a topic is suggested as a favorite as indicated by for example the ‘X’ in the ‘Fly Fishing’ suggested topic indicator 1150a. A responder may accept a suggestion by activating a suitable suggested topic indicator, which may cause a suggested topic indicator to be indicated by a filled rectangle. A responder may reject a suggestion by activating a suitable suggested topic indicator which may cause a suggested topic indicator to be indicated by an empty rectangle. The suggested acceptance indicators 1155 may be used to indicate a suggestion that requests associated with a topic will be accepted. For example the ‘X’ in the suggested topic acceptance indicator 1155b may indicate that requests associated with ‘Russia’ are recommended to be accepted. The suggested blocking indicators 1160 may be used to indicate that requests associated with a topic are recommended to be blocked. For example, the ‘X’ in the registered blockade indicator 1160c may indicate that requests associated with ‘Guns’ are recommended to be blocked. A user may be able to sort topics in the suggested topic area 1140 based on whether a topic is recommended as a favorite, accepted, or blocked. A search facility may be provided for a user to locate a suggested topic. Suggested topics may be presented in an order based on ranking of suggested topics. A user may navigate through content of the suggested topic area 1140 using typical navigation features as are well known in the art. The action controls 1165 may be used to take actions regarding information indicated in the GUI 1100. The ‘Cancel’ action control 1165a may be used to exit the GUI 1100 without saving changes made in the GUI 1100. The ‘Save’ action control 1165b may be used to save information indicated in the GUI 1100.

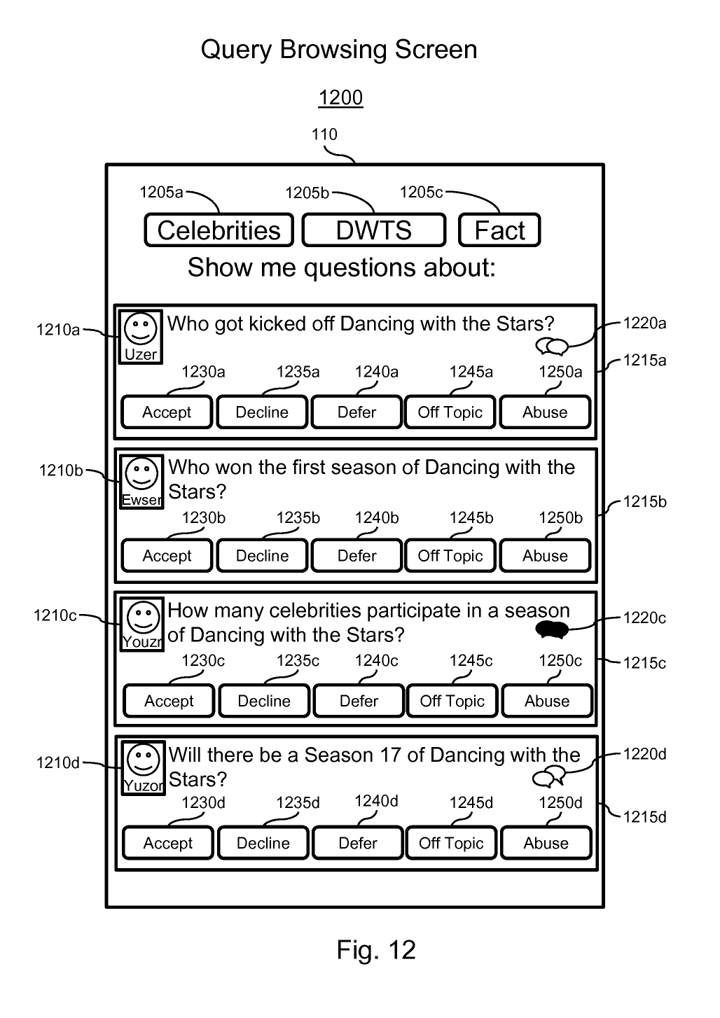

As illustrated in FIG. 12 an exemplary query selection GUI 1200 is provided. The GUI 1200 may be provided to a user, a responder, a guide, etc. The GUI 1200 may be presented using a system such as the user system 125 (FIG. 1). The GUI 1200 may be used to obtain information of a query. The GUI 1200 may include selection indicators 1205a-1205c, query indicators 1215a-1215d, user indicators 1210a-1210d, conversation indicators 1220a-1220d, acceptance indicators 1230a-1230d, decline indicators 1235a-1235d, defer indicators 1240a-1240d, off topic indicators 1245a-1245d, and abuse indicators 1250a-1250d.

As illustrated in FIG. 12, the topic indicators 1205 may include a category, type, etc. which may be used to select a query. The selection indicator 1205a may indicate that questions regarding ‘Celebrities’ and ‘DWTS’ are desired. The selection indicator 1205c may indicate that queries classified as ‘Fact’ are to be provided. The user indicators 1210a-1210d may indicate information of a user associated with a request. For example, the user indicator 1210b shows that ‘Ewser’ has submitted the query ‘Is there a black hole in the middle of the Milky Way galaxy?’ as indicated in the query indicator 1215b. As illustrated in FIG. 12, the conversation indicators 1220a, 1220c, 1220d may indicate that a user associated with a request is available for a two-way communication. For example, the conversation indicator 1220a may indicate that ‘Uzer’ is available for a real-time exchange of information as indicated by the clear speech bubbles in the conversation indicator 1220a. Likewise the absence of a conversation indicator associated with the query indicator 1215b may indicate that communication with a user associated with the query does not accept two-way communications. Similarly the filled conversation indicator 1220c may indicate that a user associated with a query is not currently accepting two-way communication. Any suitable indicator such as color, shading, etc. may be used to indicate status of the conversation indicators 1220a, 1220c, and 1220d.

The acceptance indicators 1230a-1230d may be used to indicate that a responder accepts to respond to a request. Activation of the acceptance indicator 1230a may cause a GUI such as the GUI 1200 depicted in FIG. 12 to be provided. Activation of an acceptance indicator may cause a ranking of a topic associated with an accepted query to be increased for a responder. The decline indicators 1235a-1235d may be used to indicate that a responder declines to answer a request. Activation of the decline indicator 1235b may cause the query indicator 1215b to be closed and replaced by a different query indicator. The defer indicators 1240a-1240c may be used to indicate that a responder defers to respond to a request. If a responder activates the defer indicator 1240c, the query indicated in the query indicator 1215c may be replaced, but may be offered to the responder at a later time. The off topic indicators 1245a-1245d may be used to indicate that a query is incorrectly associated with a topic. For example, activation of the off topic indicator 1245d may cause the query indicated by the query indicator 1215d to be ranked lower for the topics ‘Celebrities’, ‘DWTS’ and ‘Fact’, and may cause the query indicator 1215d to be replaced by another query indicator. The abuse indicators 1250a-1250d may be used to indicate that a request is inappropriate or offensive. Activation of the abuse indicator 1250c may cause a ranking or rating of a user indicated in the user indicator 1210c to be affected, and may cause the query indicator 1215c to be replaced by another query indicator.

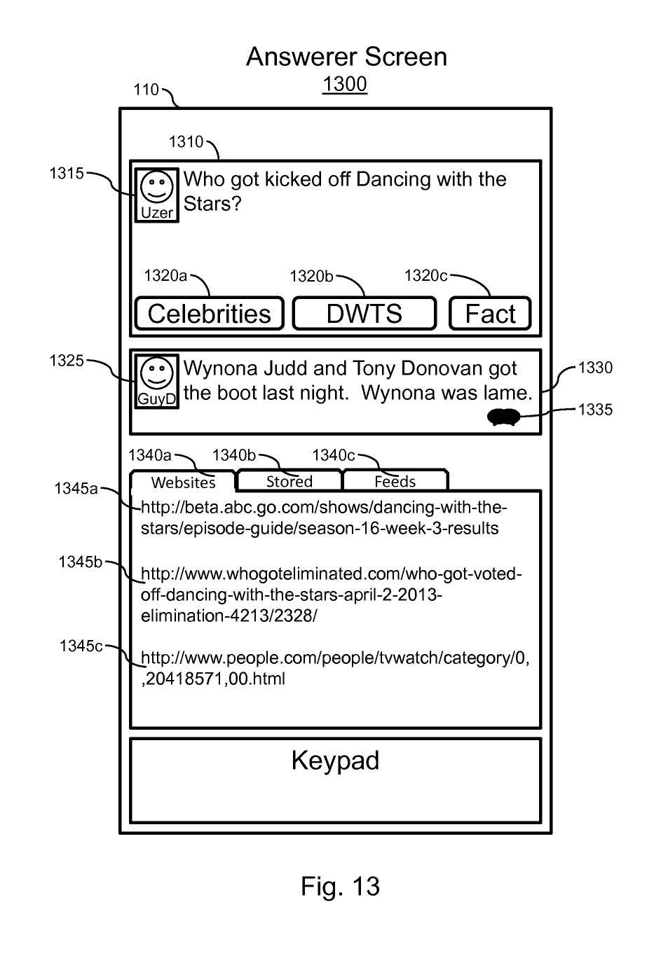

An exemplary GUI 1300 for responding to a factual query is illustrated in FIG. 13. The GUI 1300 may be provided to a responder when a responder elects to respond to a factual request. The GUI 1300 may be provided using a device such as the user system 105 (FIG. 1). The GUI 1300 may include a query indicator 1310, a user indicator 1315, query category indicators 1320a-1320c, a responder indicator 1325, a response indicator 1330, a conversation indicator 1335, response type indicators 1340a-1340c, and response indicators 1345a-1345c.

The query indicator 1310 may be used to indicate information of a query to which a responder has chosen to respond. The user indicator 1315 may be used to indicate information of a user associated with a request. The category indicators 1320a-1320c may be used to indicate information associated with a request, which may be used to select requests. The responder indicator 1325 may be used to indicate information of a responder associated with a response indicated in the response indicator 1330. The conversation indicator 1335 may be used to indicate whether a responder indicated in the responder indicator 1325 is accepting messages. Activation of the conversation indicator 1335 may cause a communication session to be established with a responder. The response type indicators 1340a-1340c may be used to indicate a type of response which has been obtained associated with the indicator. For example, the response type indicator 1340a may provide snippets obtained from websites based on any or all elements of a request when activated. The response type indicator 1340b may provide responses associated with stored responses to previous requests which are selected based on any or all elements of a request when activated. The response type indicator 1340c may provide results obtained from RSS feeds, data providers, etc. when activated. The response indicators 1345a-1345c may be used to provide information of responses which may be appropriate. For example, the response indicator 1345b may provide details of a response when activated. While the user interfaces described herein have been illustrated using particular types and numbers of interface elements, no limitation is implied thereby, Any number and type of user interface elements as are well known in the art may be used to implement the functionalities described without departing from the scope and spirit of the embodiments described herein.

Using the methods and systems described herein resources are allocated for responding to a request. Resources may include search engines, databases, and/or other sources of information. Resources may include human assistants or guides and/or peer answerers or responders. Resources may be allocated based on a ranking of resources, requests, and/or users. A resource ranking may be used to determine which requests will receive a response and a type of response a request will receive. A dynamic allocation of resources may be affected by actions of guides, users, and responders.

Allocation of resources may be performed based on selected sets of information. A set of information may be processed in real-time and/or after a request has been processed.

In a system in which peer answering is implemented, it is important to optimize utilization of persons who have registered to accept questions. In general, a user will be more likely to respond to a question of interest than to a question outside the person's area of interest. This is similar to the “Wikipedia Effect” where a person with a particular interest will act as an author and/or curator of a web page on a topic. This approach allows for ownership of the page, which helps to eliminate the need for compensation of the author.

In a similar manner a person may be willing to register to answer questions on a particular topic of interest. An enthusiast may even be willing to perform research in order to respond to a question posed by a person with casual interest in a topic. If a user receives frequent queries which are not in topics of interest or which are too easy or too difficult, the user may become frustrated and cease responding.

When it is desirable that a person submitting a question receives a response quickly the allocation is further complicated as there may be a trade-off between expertise and topical interest. In order to alleviate this it is desirable to have any answerer associated with as many topics of interest as can be found. However it may be difficult to elicit such information from a responder.

A system is provided which allows users to submit requests for information or queries and receive a response. A user may register to receive queries and respond to queries. A server may be provided to track queries and distribute queries between users. A server may include a database of stored queries and answers which may be used to respond to users. A server may use automated information sources such as RSS feeds, databases and data feeds to respond to user queries. A server may direct queries to answerers who are willing to answer any query, and who may be paid searchers. A server may direct queries to answerers who may redirect, classify and/or interpret queries.

In order to improve availability of answerers the system may record user preferences for receiving queries. A user may be encouraged to register for categories and/or topics of interest. If a user registers for a topic, the user may be asked whether related topics and/or general categories of queries are of interest. A system taxonomy may be structured based on keywords which may be used to infer related topics and/or categories which are suggested to a user. A user may be permitted to select between a favorite topic (i.e., a preferred topic) and topics of casual interest. When a user asks a question, topics associated with the question may be offered to the user as potential areas of interest. A user may block queries associated with a topic or category.

A user may be rated for a topic, category, etc. A user may be rated in various ways. For example, if a user ignores notifications of queries regarding a topic, a rating of the user for the topic may be decreased. Similarly if a user responds to notifications of queries regarding a topic a rating of the user for the topic may increase. Such a rating may be used to determine whether a query associated with a particular topic may be offered to a user when the query requires an immediate response.

A rating of a user may be based on ratings of other users. For example, if a user is notified of a query the user may be provided with various options for responding. For example a user may decline to answer the question, may defer answering, may respond that the query is misclassified, may respond to a user to request clarification, may add a classification or change classification of a query, etc. Any action of a user may be tracked to determine a rating of a user for a topic. For example, if a user responds to a query an expertise rating of the user for the query may be increased relative to a user that submitted the query. If a user reclassifies a query associated with a topic, and a user associated with the new classification responds to the query, a rating of the user for the topic may be increased. If a user defers to respond to a query, but produces a response which is rated highly by a user submitting the query, a rating of the user for expertise in the topic may be increased. If a user responds with a request for clarification a rating of the user for the topic of the question may be adjusted based on whether the user submitting the question responds to the request for clarification.

When a query is received a user selected based on a topic associated with the query. A number of users may be notified of the query based on the topic, and a response time rating for the users. If a response is not received from a notified user within a predetermined time period a second group of users may be notified of the query. The second group of users may be selected based on ratings of relatedness of the query to the topics of the user and expected response rating of the users. If a response is not received from a user within a predetermined time period of the second notification the query may be passed to a generalist who is willing to accept queries for any topic or category. If a user has been notified of a query and has not responded within a predetermined time period notifications to the user may be blocked for a predetermined time interval. A user may be more likely to be notified of a query if the user has recently asked a question or received or read a notification of an answer.

A number of users notified for a query may be determined based on a topic and/or a level of expertise required for the query. For example, if a high percentage of users notified of a query associated with a topic respond to the query a number of users selected for queries associated with the topic may be reduced. Similarly, if a novice level user declines to answer a query, a number of more experienced users may be notified of the query.

A number of users notified of a query may be based on a user submitting the query. For example, if a user is a novice at answering questions in a particular category questions submitted by the user may be directed to users who are of a similar level of expertise or experience.

A system is provided which includes a user system for submitting a query and receiving a response, a search server receiving the query, a database storing information of queries, search results, searchers, responders, users, resources and other information, a responder system receiving a query and providing a response, and a resource system providing answers and/or other media responsive to a request or query or search request or question.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A determination regarding whether a query is a request for objective or factual information or is a request for subjective or opinion information may be made. A query may be determined to be factual in various ways. Automated analysis may be used to determine if a request is seeking factual information. Content of a request may be used to determine whether the query is factual. A user may indicate whether a query is factual. A user may be provided with a control which indicates whether a query is factual. A query may be determined to be factual based on actions by a responder or other person to whom a query is presented.

A layer of processing may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use. Automated processing of a query which is determined to be factual may be different from automated processing of a query which is determined to be subjective. For example, a match to a subjective query may be less precise than a match to an objective query. Different resources may be used to determine a response to a subjective query than a factual query.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources. An expediter may be used to determine whether a query is subjective or objective. If a query is determined to be subjective an expediter may not be presented with the query.

A third layer of processing of a query may include a human assistant who responds to the query or “searcher”. A searcher or responder or answerer may receive a query, an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. Selection of a responder for a subjective query may be different than selection of a responder for an objective query. A more general matching may be applied for selection of a responder for a subjective query. An objective query may be directed to a responder based on a type and level of knowledge required to respond to the query.

A responder or answerer may be provided with alternative responses to a request. An answerer may be presented with resources and/or snippets extracted from resources based on content of a request. An answerer may be presented with materials from a database of previous questions. An answerer may be allowed to indicate a question is too difficult, off topic, or subjective. A question may be indicated as objective or subjective to an answerer. An answerer may be able to sort objective and subjective questions based on various criteria such as keywords, temporal data, difficulty, etc.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services. A resource may be ranked or evaluated based on a type of response which is to be obtained from the resource. A resource may be ranked based on a category, a topic, a keyword, a level of information provided, a type of information such as objective and/or subjective, etc.

Responders may be associated with topics in order to assist in assigning a request to a responder. Topics may be determined based on a corpus of requests, responses, documents, etc. Topics may be restricted to a predetermined number or type of word and/or phrase. A responder may elect to be associated with a topic as a “favorite” or preferred topic, as an accepted topic, and or as a provisional association based on topics associated with queries submitted by a responder and/or answered by a responder. A responder may elect to block a topic.

A rating of a responder for a request may be determined based on various criteria. A number of responders associated with a topic may influence a rating of a responder for a topic. A number of queries submitted regarding a topic may influence a rating or probability that a responder will receive a notification of a request associated with a topic. A time interval between an activity of a responder and receipt of a request may affect a probability or ranking of a responder for a topic and/or a request. Topics assigned to a responder may affect a ranking of a responder for a topic. For example, if a responder is associated with two topics, a ranking for a more frequently submitted topic may be higher than a ranking for a less frequently submitted topic when the responder is more probable to respond to the less frequently submitted topic. A ranking of a responder may be based on a difficulty rating associated with a topic. For example if a difficult query is associated with a topic, a probability that a responder will answer a difficult query may affect a ranking of the responder for the topic.

A group of responders may be notified of a request. For example, a number of highest ranking responders for a topic associated with a query may be notified of the query. A number of responders notified may be determined based on a topic of a request. For example if responders respond to queries associated with a topic more often, a lower number of responders may be notified. Similarly a type of information sought may affect a number of responders notified. For example, if a request is seeking factual information, a number of responders notified may be increased.

A time interval between an action of a responder and a notification may affect whether a responder will be notified of a request. If a responder has submitted a request, a ranking of a responder to receive a notification of a request associated with a topic indicated by the request may be increased. If a responder has been notified of a request a time interval may be required to elapse before another notification is sent to the responder. If a responder does not respond to a notification within a predetermined time interval, a time interval between a most recent notification and a subsequent notification may be increased in a linear, logarithmic, polynomial, exponential, etc. progression.

As used herein, a “request” means a request for information, products, and/or services. A request or search request or query or question may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “responder”, “answerer”, “expediter”, “transcriber”, “specialist” or “generalist”. Guides may be assigned various roles. A guide may be a user. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

As used herein, a “topic” may be any word, phrase or other form of metadata which can be associated with a request based on the request. A topic may include a keyword, category, named entity, classification, a location, a source, etc. A topic may be assigned to a request or query automatically and/or using the assistance of a person such as a guide, user, or responder.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide, a resource and/or a search system may include conversion of text to speech and speech to text. Any type of media which can be sent and/or received using a communication system may be part of a communication session. A communication session may be conducted using any or all communication services associated with a user, a guide, a resource, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

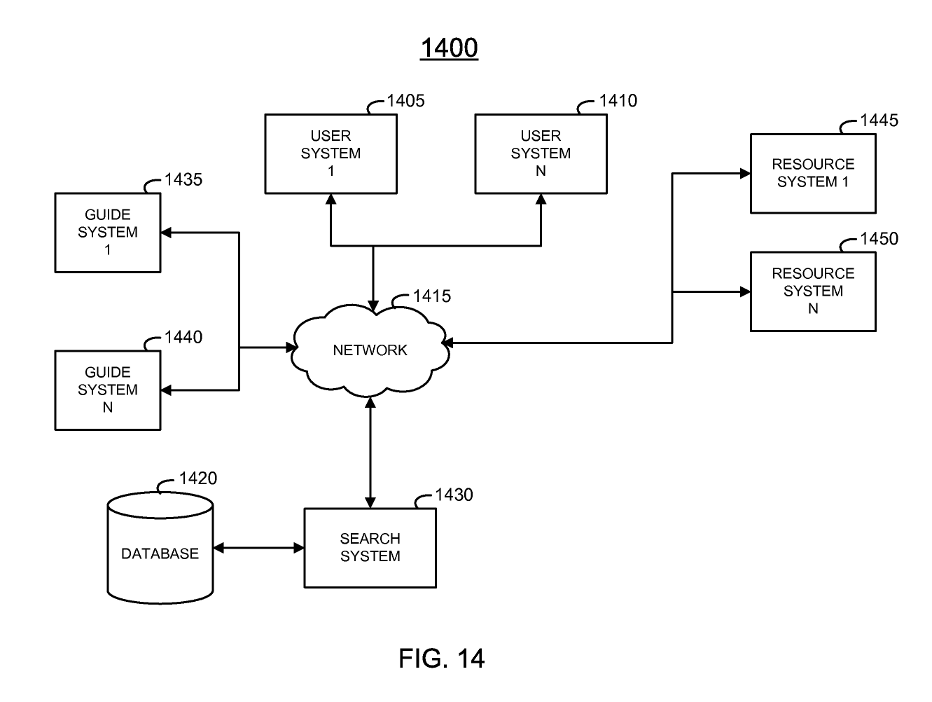

As illustrated in FIG. 14, system 1400 includes user systems 1405, 1410, a network 1415 such as the Internet, a search system 1430, a database 1420, which may comprise various records, guide systems 1435, 1440, and resource systems 1445, 1450.

While only a few systems associated with a user, a resource, and a guide or responder are depicted in FIG. 14 it is within the scope of the disclosure for multiple systems for a user, resource, responder and guide to be utilized. In particular it is envisioned that many user, resource and guide systems may be implemented. The search system 1430 may be composed of many components as described further herein.

Any user system (e.g. the user system 1405) can be used, to submit a request to the search system 1430 and/or receive a result and/or other information. Any user system may receive and/or provide a response, and/or may provide compensation to the search system 1430.

The network 1415 may be a global public network of networks (i.e., the Internet) and/or may consist in whole or in part of one or more private networks and communicatively couples the user systems 1405, 1410, the guide systems 1435, 1440, and the resource systems 1445, 1450 with the other components of the system such as the search system 1430, and the database 1420. The network 1415 may include one or more wireless networks which may enable wireless communication between the various elements of the system 1400. For example, the search system 1430 may receive messages which may be routed via a wireless network controlled by a wireless service to the user systems 1405, 1410. A wireless service may receive messages from the guide systems 1435, 1440 via a wireless network which is a part of the network 1415, and provide the messages to the search system 1430 via an internet connection which is part of the network 1415. Similarly a voice communication via wired and/or wireless communication might be established between any elements of the system 1400.

The search system 1430 allows interaction to occur among the user systems 1405, 1410, the guide systems 1435, 1440, and the resource systems 1445, 1450. For example, a request can be transmitted from the user system 1405 to the search system 1430, which may provide information obtained from the database 1420, which may include an advertisement to the user system 1405. Similarly, a search result from an answerer operating the guide system 1435 and/or the resource system 1445 might be routed to the search system 1430, which might process the search result, formulate a response and provide a message to the user system 1405. Any type of communication between users, resources and/or guides may be mediated and/or facilitated by the search system 1430, and/or other elements of the system 1400.

The search system 1430 is communicatively coupled with the database 1420. As will be described herein in further detail below, the database 1420 includes data that is processed in association with operation of the embodiments. Although FIG. 14 illustrates the database 1420 as a separate component of the system, the database 1420 may be integrated with the search system 1430. Further, the records maintained in the database 1420 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 1420 may reside in any suitable elements of the system 1400. Any or all elements of the system 1400 may include any or the entirety of the database 1420.

The user systems 1405, 1410, the guide systems 1435, 1440, the resource systems 1445, 1450 and the search system 1430 may include equipment, software, systems and personnel required to send and/or receive messages between a user system 1405, 1410, the guide systems 1435, 1440, the resource systems 1445, 1450 and/or the search system 1430 using the network 1415. The database 1420 includes information which may allow the search system 1430 to establish communication between any or all of the elements of the system 1400.

A user system, a guide system, and/or a search system may be a desktop, portable, or tablet PC or Mac®, a mobile phone, a smart phone, a PDA, a server system, a wearable computing device, a landline phone, a specialized communication terminal, a terminal connected to a mainframe, or any other communication hardware and/or system. The search system 1430 may include one or more servers, computers, etc. For example, servers such as the PowerEdge® 2900 by Dell, or the BladeCenterJS22 by IBM, or equivalent systems might be used to implement elements of the search system 1430. The search system 1430 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, resource systems and/or to implement the search system 1430.

A user may be identified by the search system 1430. When a user system, such as the user system 1405, establishes a communication session with the search system 1430, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 1405 and a resource system, a guide system, a sponsor system and/or the search system 1430. Information such as a keyword, a category, a user profile, a request, a result, etc., may be associated with a user. A user may be required to provide profile information to the search system 1430. A user may elect to receive requests from the search system 1430 (i.e., a user may elect to act as a responder). Parameters and/or attributes may be associated with a user and/or a resource as will be further described herein below. Information of a user may be stored in the database 1420.

A guide or answerer may be required to register with the search system 1430. As part of a registration process, at least one communication method is associated with a guide. In at least one embodiment, a guide may register with the search system 1430 and establish a username and password which are associated with the guide. A guide may login to the search system 1430 using a web browser functionality of the guide system 1435 in order to communicate with the search system 1430. Multiple communication services may be associated with a guide and may allow a communication session to be established between a guide system such as the guide system 1435 and a user system, a resource system, a sponsor system, and/or the search system 1430. Multiple identifiers of a guide may be associated with each other. Information such as IM credentials, an email address, a phone number, a URL, a username, etc., of a guide may be identified which may allow the search system 1430 to establish a communication session between a guide system and a user system, a resource system, a sponsor system and/or the search system 1430.

When a guide registers with the search system 1430 the guide may be associated with one or more topics, keywords, categories, profiles, and/or other information. Information associated with a guide may be stored in the database 1420 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 1430. For example, a guide may be assigned to a role such as translator, transcriber, expediter, generalist, specialist, auditor, etc. A guide may be registered by a sponsor. A sponsor may provide compensation to a sponsored guide. A sponsor may designate personnel associated with the sponsor as responders.

Records may be maintained in the database 1420 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

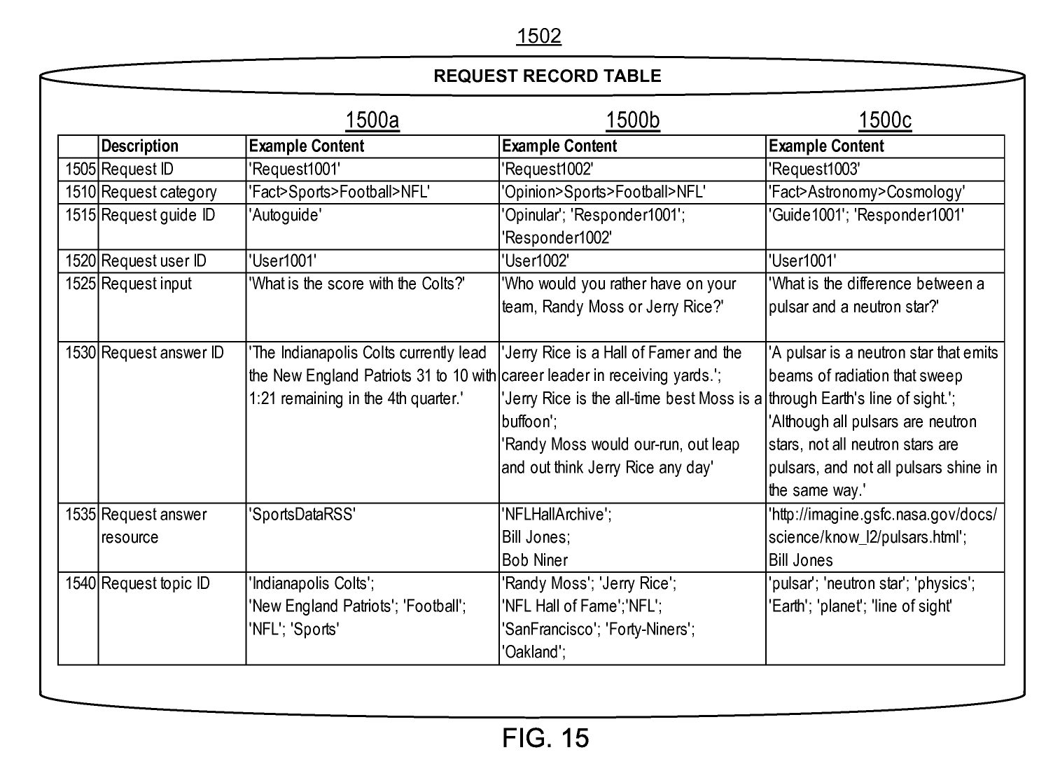

As illustrated in FIG. 15 an exemplary request record table 1502 which may comprise a number of request records is provided. One or more may request records be associated with or resident in the database 1420 (FIG. 14). While a few request records are depicted in FIG. 15, it is anticipated that many request records may be employed in operation of the embodiments. The request record table 1502 may include information of requests which may be processed. The request records 1500 may include a request ID field 1505, a request category field 1510, a request guide ID field 1515, a request user ID field 1520, a request input field 1525, a request answer ID field 1530, a request answer resource field 1535 and a request topic ID field 1540.

The request ID field 1505 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 1505. In at least one embodiment, a random number is indicated in the request ID field 1505. Using the example in FIG. 15, ‘Request1001’ is the request ID associated with the request record 1500a.

The request category field 1510 may include information of a category associated with a request. Information indicated in the request category field 1510 may be used to select an item associated with a request. For example, a category associated with a request may be used to rank responders who may be associated with the type of request. Likewise, a category associated with a request may be used to rank requests which may be presented to a guide. A category associated with a request may be determined based on factors such as keywords of a query, a profile of a user, a selection of a guide, a user history, an action of a user, an action of a responder, etc. A category associated with a system taxonomy may be indicated in the request category field 1510. A category may be associated with a request automatically and/or using the assistance of a person. Using the example in FIG. 15, ‘Request1002’ may be categorized as ‘Opinion>Sports>Football>NFL’ as indicated in the request record 1500b. This may indicate that a person or item associated with the category ‘Opinion>Sports>Football>NFL’ may have a higher ranking for responding to ‘Request1002’. A category of a request may be associated with a user submitting the request. Content of a request such as a keyword, named entity, topic, etc. may be used to assign a category or type to a request. A classification as subjective or objective may be required in order that a request may be submitted.

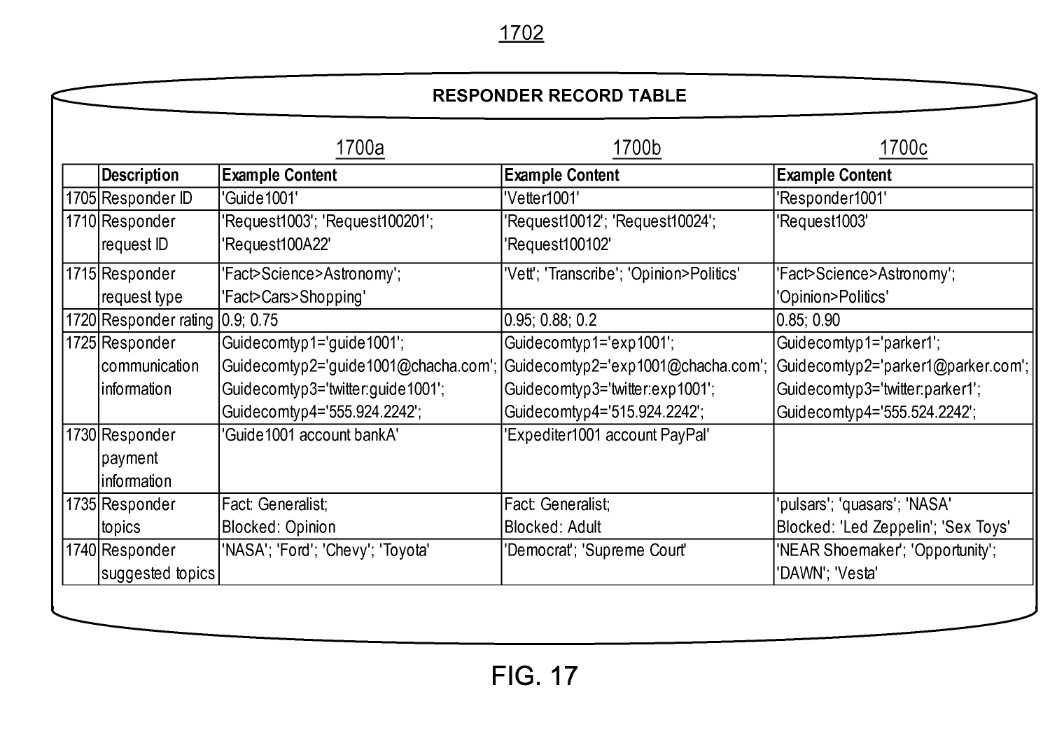

The request guide ID field 1515 may include information of a number of guides associated with a request. Content of the request guide ID field 1515 may be used to obtain information of a guide using a record such as the responder record 1700b (FIG. 17). If a person is selected for a request, elects to receive a request, provides a response to a request, reviews a result of a request and/or completes a request, an identifier of the person may be indicated in the request guide ID field 1515. Using the example in FIG. 15, ‘Opinular’, ‘Responded 001’ and ‘Responded 002’ are associated with ‘Request1002’. This may for example indicate that ‘Request1002’ has received an automated response from ‘Opinular’ and a response from ‘Responder1001’ and ‘Responder1002’.

The request user ID field 1520 may include information of a number of users associated with a request. Content of the request user ID field 1520 may be used to obtain information of a user associated with a request. For example, if a request is submitted by a user, an identifier of the user may be indicated in the request user ID field 1520. A request may not be associated with a user. For example, the search system 1430 (FIG. 14) may provide requests to persons which are not directly related to a user request. The search system 1430 may provide a request to a responder based on a selection of the request by a user, a responder, an advertiser, etc. Using the example in FIG. 15, ‘Used 001’ is associated with ‘Request1001’ and ‘Request1003’ and ‘Used 002’ is associated with ‘Request1002’ as indicated in the request record 1500b. This may indicate that ‘Request1001’ and ‘Request1003’ were submitted by ‘User1001’ while ‘Request1002’ was submitted by ‘Used 002’.

The request input field 1525 may include information of a request. Content of the request input field 1525 may be provided to a person who accepts a request. Content of the request input field 1525 may include any type of information. For example, a pointer to audio, video, text, and/or other media may be indicated in the request input field 1525. As illustrated in FIG. 15, the query ‘What is the difference between a pulsar and a neutron star?’ is the request input associated with ‘Request1003’, as indicated in the request record 1500c. In at least one embodiment, the request input field 1525 may indicate an original user request, a categorization, and a rewritten user request.

The request answer ID field 1530 may include information of a response associated with a request. Content of the request answer ID field 1530 may be provided to a user responsive to a request. Content of the request answer ID field 1530 may be stored in the database 1420 (FIG. 14). Content of the request answer field 1530 may be reviewed and/or rated by a user, a guide, an answerer and/or an administrator. As illustrated in FIG. 15, the responses ‘A pulsar is a neutron star that emits beams of radiation that sweep through Earth's line of sight.’, and ‘Although all pulsars are neutron stars, not all neutron stars are pulsars, and not all pulsars shine in the same way.’ are associated with ‘Request1003’ as illustrated in the request record 1500c. While a text response to a query is used for the purposes of illustration, any type of media may be indicated in the request answer ID field 1530. In at least one embodiment, a text response and a URL associated with a source of the text response may be indicated in the request answer ID field 1530. In at least one embodiment, a responder may select a response which may cause a URL associated with the response to be inserted in the request answer resource field 1535.

The request answer resource field 1535 may include information of a resource associated with a request. Content of the request answer resource field 1535 may be used for various purposes. A URL associated with a response may be used to determine whether a response is reliable. As illustrated in FIG. 15, a URL associated with an RSS feed is associated with ‘Request1001’ which may indicate that a response associated with ‘Request1001’ must be treated according to a pre-determined set of rules. For example, an opinion-type response associated with a particular responder may be more likely to be reused based on a rating of the responder. For example, if a user votes a response of a responder as positive a future response of the responder which is associated with a category of the response may be more likely to be presented. A response to a subjective request may be obtained from a resource such as the resource ‘NFLHallArchive’ indicated in the request answer resource field 1535. If a response is not received from a responder within a predetermined time period of receipt of a request a response extracted from a resource may be provided. Likewise if less than a pre-determined number of responses are returned a response obtained from a resource may be provided. For example, a snippet including a named entity indicated in a user request may be extracted from a resource, which snippet may be provided responsive to a request. Using the example in FIG. 15, the sentence ‘Jerry Rice is a Hall of Famer and the career leader in receiving yards.’ Might be extracted from ‘NFLHallArchive’ based on the presence of the named entity ‘Jerry Rice’. As the query is subjective, the response may be accepted and/or relevant despite not being a direct answer to a user query.

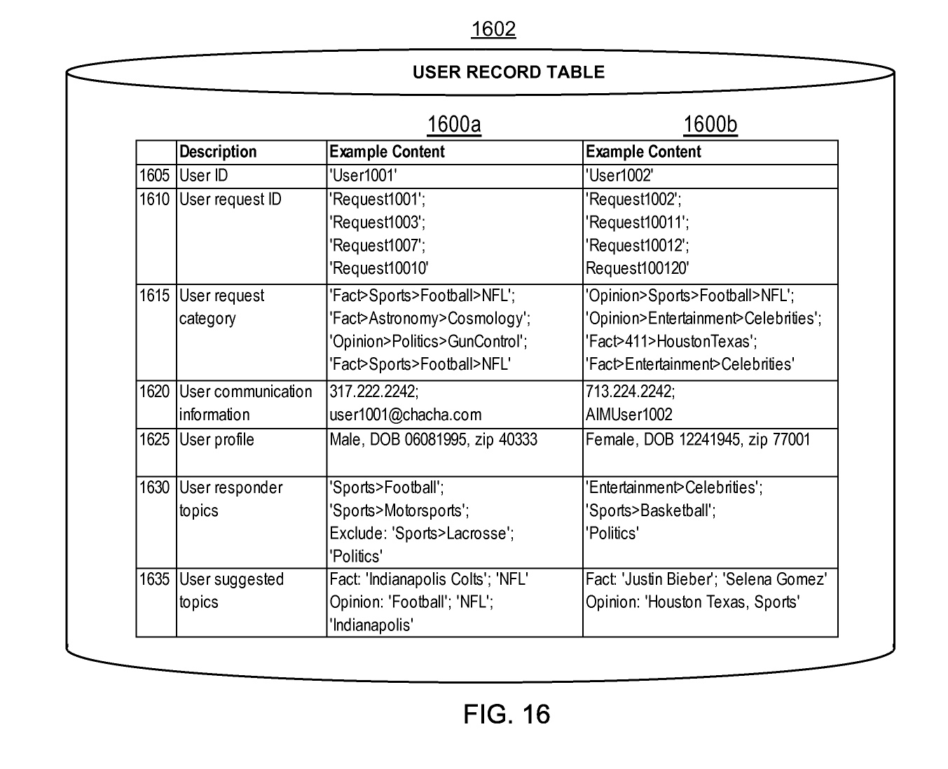

As illustrated in FIG. 16 an exemplary user record table 1602 which may comprise a number of user records is provided. One or more user records may be associated with or resident in the database 1420 (FIG. 14). The user record table 1602 may include information of users. The user records 1600 may include a user ID field 1605, a user request ID field 1610, a user request category field 1615, a user communication information field 1620, a user profile field 1625, a user responder topics field 1630, and user suggested topics field 1635.

The user ID field 1605 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 1605. Using the example in FIG. 16, ‘User1001’ is the user ID associated with the user record 1600a.

The user request ID field 1610 may include information of a number of requests associated with a user. A user request ID may be for example a pointer to a request record associated with a request submitted by a user. If a user submits a request, a request ID may be added to the user request ID field 1610. Using the example illustrated in FIG. 16, ‘Request1002’, ‘Request10011’, ‘Request10012’ and ‘Request100120’ are associated with ‘User1002’ as indicated in the user record 1600b. This may indicate that ‘Used 002’ has submitted ‘Request1002’, ‘Request10011’, ‘Request10012’ and ‘Request100120’.

The user request category field 1615 may include information regarding a category, type, etc. associated with a user request. For example, if a request is directed to a type of processing or a category, etc. a type and/or category associated with the processing may be indicated in the user request category field 1615. In at least one embodiment, the user request ID field 1610 and the user request category field 1615 are linked by for example a pointer. In at least one embodiment, a user may be restricted to submitting questions which are subjective, objective, etc. A user may be restricted to accepting subjective, objective, etc., requests. Content of the user request category field 1615 may be used to determine categories of queries which may be directed to a guide, a user and/or a resource. Content of the user request category field 1615 may be used to rank resources, guides, advertisements, etc. and may affect a probability that an item will be presented to a user, guide and/or responder.

The user communication information field 1620 may include information of a number of communication services associated with a user. Any information which may be used to establish communication with a user may be indicated in the user communication information field 1620. For example, a telephone number, an email address, an IM credential, a URL, a username, a password, and/or other communication information may be indicated in the user communication information field 1620. Using the example in FIG. 16, the phone number ‘317.222.2242’ and the email ‘user1001@chacha.com’ are associated with ‘User1001’.

The user profile field 1625 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 16, ‘Female, DOB 12241945, zip 77001’ are associated with ‘User1002’. Profile information may be used to match information provided by a user to other information. For example, a ranking of a guide for a query of a user may be adjusted based on a profile associated with the user. An answer might be modified based on geographic, demographic, etc. profile information of a user. A responder, guide and/or resource might have a different rating and/or ranking based on profile information of a user.

The user responder topics field 1630 may include information of topics associated with a user for which the user may be selected as a responder. The user responder topics field 1630 may include topics for which a user has elected to receive questions and/or topics for which a user has requested not to receive questions. Content of the user responder topics field 1630 may be used to rate a user for a request. As illustrated in FIG. 16, a query associated with ‘Politics’ or ‘Sports’ might be directed to ‘User1001’ and ‘Used 002’, but if the query is associated with ‘Sports>Lacrosse’ ‘User1001’ would not receive the query as that category may have been excluded by ‘Used 001’ as indicated in the user responder topics field 1630 of the user record 1600a. A user may elect to receive and/or exclude subjective and/or objective requests associated with a category.

The user suggested topics field 1635 may include information of topics suggested for a user. Topics may be associated with a type of query such as fact, opinion, conversational, etc. As illustrated in FIG. 16, factual queries associated with the topics ‘Justin Bieber’ and ‘Selena Gomez’ and opinion questions associated with the topics ‘Houston Tex.’ and ‘Sports’ might be suggested as registration topics for ‘User1002’. For example, a factual query may require domain specific expertise on a topic, while an opinion query may require general interest in a topic. Topics indicated in the user suggested topics field 1635 may be ranked for presentation to a user. While a limited number of topics are used for the purposes of illustration, it is envisioned that large numbers of topics may be used, and that various types may be assigned to requests and/or topics in a process of distribution of requests.

As illustrated in FIG. 17 an exemplary responder record table 1702 which may comprise a number of responder records is provided. One or more responder records may be associated with or resident in the database 1420 (FIG. 14). The responder record table 1702 (FIG. 17) may include information of responders. The responder records 1700 may include a responder ID field 1705, a responder request ID field 1710, a responder request type field 1715, a responder rating field 1720, a responder communication information field 1725, a responder payment information field 1730, a responder topics field 1735 and a responder suggested topics field 1740.

The responder ID field 1705 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 1705. In at least one embodiment, a pseudonym selected by a responder may be indicated in the responder ID field 1705. A first and last name of a responder may be indicated in the responder ID field 1705. Using the example in FIG. 17, ‘Guide1001’ is the responder ID associated with the responder record 1700a.

The responder request ID field 1710 may include information of a number of requests associated with a responder. Content of the responder request ID field 1710 may be used to obtain information of a request. For example, if a user request has been determined to require a number of requests to be performed, the search system 1430 (FIG. 14) may assign a unique ID to the requests and may distribute information of the requests to responders. Using the example in FIG. 17, ‘Vetter1001’ is associated with ‘Request10012’, ‘Request10024’ and ‘Request100102’ as indicated in the responder record 1700b. This may indicate that ‘Vetter1001’ has responded to those requests by for example classifying, transcribing, clarifying, etc.

The responder request type field 1715 may include information of a number of types of requests which may be processed by a responder. For example, a category and/or keyword associated with a request, a type of request, temporal information associated with a request, etc., which may be used to determine if a responder is to be presented with a request may be indicated in the responder request type field 1715. In at least one embodiment, a responder may be assigned to a particular type of request as part of a registration process. A responder may select a type of request which the responder may perform. A responder may be required to pass a test in order to be associated with a type of request. For example if a responder is to provide responses to factual queries, an assessment of a responder's knowledge of a topic may be performed. A responder may be assigned to a role such as vetter, expediter, searcher, etc., which may be indicated in the responder request type field 1715. A request indicating a keyword may be directed to a responder. Using the example in FIG. 17, ‘Responded 001’ is associated with ‘Fact>Science>Astronomy’ and ‘Opinion>Politics’ as indicated in the responder record 1700c. This may for example indicate that ‘Responder1001’ may be presented with and/or selected to respond to requests indicating those classifications, topics, etc.

The responder rating field 1720 may include information of a number of ratings associated with a responder. For example, quality, speed, peer review, response time, response frequency, etc., may be used to determine a rating of a responder. A rating of a responder may be used for purposes such as determining compensation for the responder (e.g. bonus points), selecting a responder to respond to a request, matching a request to a responder, etc. In at least one embodiment, the responder request type field 1715 and the responder rating field 1720 may be linked by, for example, a pointer. Using the example in FIG. 17, ‘Guide1001’ and ‘Responder1001’ are associated with the type ‘Fact>Science>Astronomy’ and ‘Vetter1001’ and ‘Responder1001’ are associated with the type ‘Opinion>Politics’. A response associated with ‘Guide1001’ may be more likely to be provided responsive to a request associated with ‘Fact>Science>Astronomy’, while ‘Responder1001’ might be more likely to be provided with an opportunity to respond to a request associated with ‘Opinion>Politics’ based on the ratings indicated in the responder rating field 1720.

The responder communication information field 1725 may include information of a number of communication services associated with a responder. For example, a user name and password, an email address, an IM credential, a phone number, a web page, a physical address, etc., may be indicated in the responder communication information field 1725. Using the example illustrated in FIG. 17, ‘Guide1001’ is associated with the login ID ‘Guide1001’, the email ‘guide1001@chacha.com’, the Twitter account ‘twitterguide1001’, and the phone number ‘555.924.2242’. This may indicate that ‘Guide1001’ may be contacted using the associated communication services.

The responder payment information field 1730 may include information of a payment method associated with a responder. For example, banking information, a PayPal® account, a Western Union® account, etc., may be indicated in the responder payment information field 1730. Content of the responder payment information field 1730 may be used to provide compensation to a responder. For example, payment may be made by Automated Clearing House (ACH), wire transfer, etc., using information indicated in the responder payment information field 1730. If a responder is not compensated, the responder payment information field 1730 may be blank. As illustrated in FIG. 17, ‘Expediter1001 account PayPal’ is associated with ‘Vetter1001’ as indicated by the responder record 1700b.

The responder topics field 1735 may include information on topics which may be associated with a responder. The information associated with the responder topics may be topics for which the responder has agreed to accept requests or topics which the responder has blocked and thus will not be offered requests associated with the topics. As illustrated in FIG. 17 ‘pulsars’, ‘quasars’, ‘NASA’, are topics for which ‘Responder1001’ may receive notifications and blocked topics for which ‘Responder1001’ may not receive notifications which are associated with ‘Led Zeppelin’, and ‘Sex Toys’. A responder may be ranked based upon topics associated with a responder. A higher ranking for a topic may increase a probability that a responder will be notified of a request. Topics associated with a responder may be ranked. A higher ranking topic may affect a probability that a responder may be notified of a request associated with a topic. For example, if a responder is associated with a high ranking topic, the responder may be more likely to be notified or selected or chosen to respond to a request associated with the high ranking topic or keyword.

The responder suggested topics field 1740 may include information of topics which may be recommended or suggested to a responder. Content of the responder suggested topics field 1740 may include topics for which a responder has not registered for which the responder is likely to accept queries. For example, as indicated in the responder record 1700a, ‘Guide1001’ may be willing to accept queries associated with ‘NASA’, ‘Ford’, ‘Chevy’, and ‘Toyota’ Content of the responder suggested topics field 1740 may be modified based on actions of a responder. For example, if a query associated with a topic indicated in the responder suggested topics field 1740 is accepted by a responder, a ranking of a topic may be increased. Likewise, if a topic identified in the responder suggested topics field 1740 is explicitly declined by a responder, a ranking of a topic for the user may be decreased. If a topic indicated in the responder suggested topics field 1740 is accepted as a favorite, a ranking of topics associated with the topic may be increased. If a responder blocks a topic, a ranking of topics associated with the topic may be adjusted.

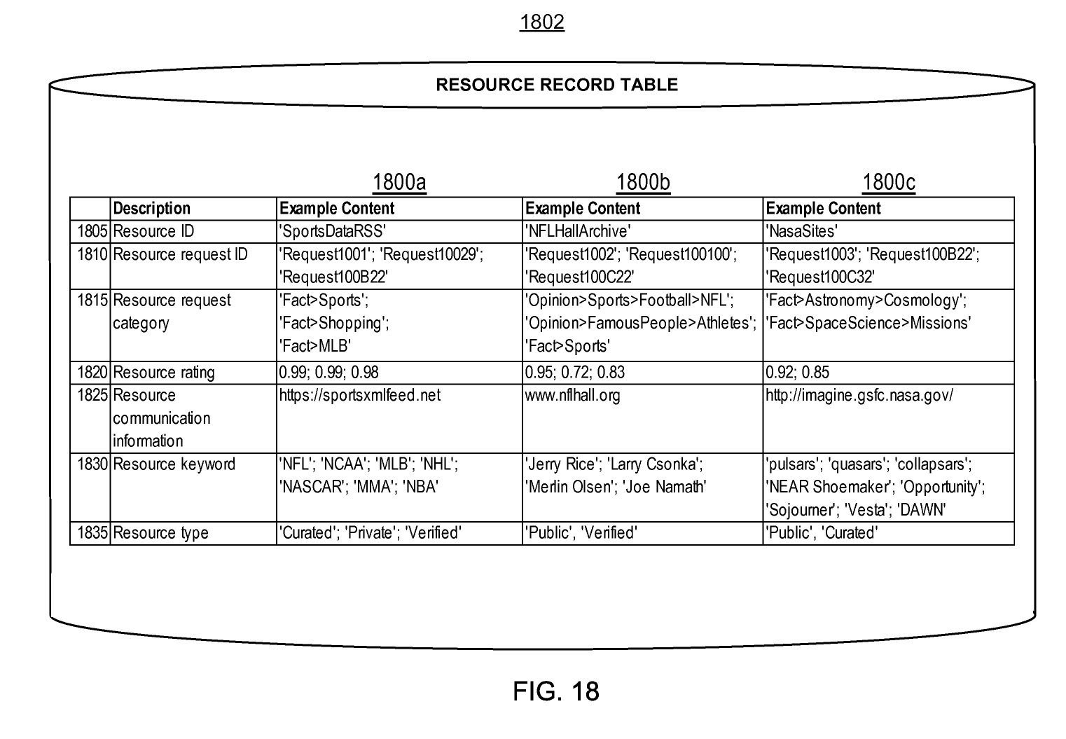

As illustrated in FIG. 18 an exemplary resource record table 1802 which may comprise a number of resource records is provided. One or more resource records may be associated with or resident in the database 1420 (FIG. 14). The resource record table 1802 (FIG. 18) may include information of resources. The resource records 1800 may include a resource ID field 1805, a resource request ID field 1810, a resource request category field 1815, a resource rating field 1820, a resource communication information field 1825, a resource keyword field 1830, and a resource type field 1835.

The resource ID field 1805 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 18, ‘SportsDataRSS’ is the resource ID associated with the resource record 1800a. This may indicate that ‘SportsDataRSS’ has been used to produce a search result, and is accessible to a guide, but may not be accessible to a user.

The resource request ID field 1810 may include information of a number of requests associated with a resource. Content of the resource request ID field 1810 may be used to obtain information of a request. For example, if a resource has been used to respond to a request, an identifier of the request may be indicated in the resource request ID field 1810. Using the example in FIG. 18, ‘Request1002’, ‘Request100100’ and ‘Request100C22’ are associated with the resource ‘NFLHallArchive’ as indicated in the resource record 1800b. This may indicate that ‘NFLHallArchive’ has been utilized to respond to ‘Request1002’, ‘Request100100’ and ‘Request100C22’.

The resource request category field 1815 may include information of a number of categories of requests which may be processed by a resource. For example, a category and/or keyword associated with a request, a type of request, profile, etc., which may be used to determine if a resource and/or a result obtained from a resource is to be presented to a responder for a request may be indicated in the resource request category field 1815. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 18, ‘NASASites’ is associated with the category ‘Fact>Astronomy>Cosmology’ and ‘Fact>SpaceScience>Missions’ as indicated by the resource record 1800c.

The resource rating field 1820 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a responder, searcher or guide, to rank a response associated with a resource, etc. In at least one embodiment, the resource request category field 1815 and the resource rating field 1820 may be linked by, for example, a pointer. Using the example in FIG. 18, ‘SportsDataRSS’ has a rating of ‘0.99’ associated with ‘Fact>Sports’, and ‘NFLHallArchive’ has a rating ‘0.83’, associated with “Fact>Sports’ which may for example indicate that ‘SportsDataRSS’ is more likely to produce an acceptable response for that category. A resource may have a rating corresponding to various categories, types of information, types of tasks, keywords, etc.

The resource communication information field 1825 may include information of a number of communication services associated with a resource. For example, a user name and password, an email address, an IM credential, a phone number, a web page, a physical address, etc., may be indicated in the resource communication information field 1825. A communication service indicated in the resource communication information field 1825 may for example be used to indicate a service by which a resource may be accessed. Using the example illustrated in FIG. 18, the URL <<https://sportsxmlfeed.net>> is associated with ‘SportsDataRSS’. This may indicate that a query associated with ‘Fact>Sports’ may be submitted to that URL by for example an API.

The resource keyword field 1830 may include information of a number of keywords associated with a resource. A match to a keyword indicated in the resource keyword field 1830 may affect a probability that a request will receive a response associated with a resource. For example, a match may prohibit a query from receiving a result from a resource, may increase a ranking of a resource, may be used to associate a category or topic with a request, may identify a resource to be provided to a guide, responder, vetter, etc. In at least one embodiment, keywords included in requests for which a resource has provided an answer may be more highly ranked for a category associated with the query and the resource. Keywords extracted from processing of content indicated by a resource may be used to determine topics. For example, if a user request receives a response associated with a resource topics which match keywords obtained from the resource may be more likely or probable to be presented as suggested topics for a user.

The resource type field 1835 may include information of a number of types or characteristics associated with a resource. A type may include an indication of an access right, a commercial arrangement, a preference, quality of content, source of content, etc. A searcher or responder may elect to associate a resource with a type. A system administrator may associate a type with a resource. A provider of a resource may designate a type associated with the resource as part of a registration process. Using the example in FIG. 18, ‘SportsDataRSS’ is a ‘Verified’, ‘Private’, ‘Curated’ resource. This may indicate that content of the resource is controlled, that the resource is not accessible to the general public, and that the content of the resource is verified to be correct.

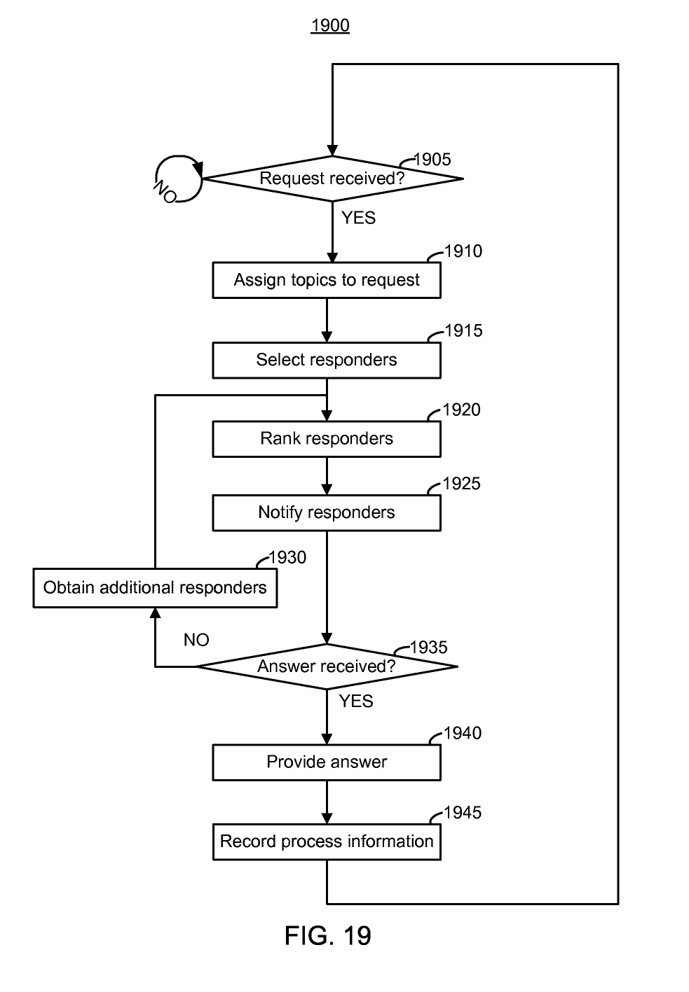

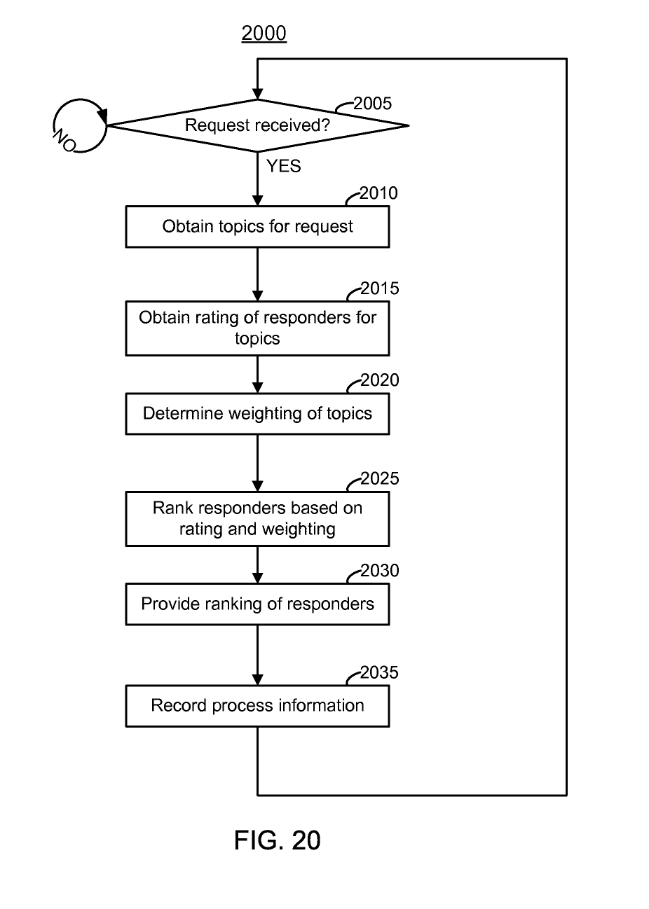

As illustrated in FIG. 19, a process 1900 for providing an answer is provided. The process 1900 may be performed in whole or in part by any suitable element of the system 1400 (FIG. 14). In at least one embodiment, the process 1900 is operative on a server associated with the search system 1430. A request may be a request for an automated answer, a human assisted answer and/or a combination thereof. The process 1900 may comprise a process such as that depicted in FIG. 20.

In operation 1905 (FIG. 19) a determination is made as to whether a request is received. If it is determined in operation 1905 that a request is not received, control remains at operation 1905 and process 1900 continues. If it is determined in operation 1905 that a request is received, control is passed to operation 1910 and process 1900 continues.

The determination in operation 1905 may be made using various criteria. In at least one embodiment, if a message is received at a system associated with the search system 1430 (FIG. 14), it may be determined that a request is received. For example, if an email message, an SMS, EMS, and/or MMS message, an IM, an IP message, and/or a voice message is received at an address associated with the search system 1430, it may be determined that a request is received. A request may be received based on chronological information. For example, if it is close to breakfast time in a particular location, a request to know the length of a waiting queue at a restaurant may be generated which may be directed to persons associated with the restaurant. If a message is received at a server associated with the search system 1430, it may be determined that a request is received.

In operation 1910 topics are assigned to a request. Topics may be assigned to a request in various ways. Content of a request may be used to associate a topic with a request. For example, keywords of a request may be used to identify a topics associated with a request, a pronoun reference of a request may be resolved to a named entity which is used to select a topic associated with a request. A profile of a user associated with a request may be used to associate a topic with a request. For example, a demographic, geographic, topical, etc. parameter of a user profile may be used to associate a topic with a request. A user, guide, responder and/or other person may associate a topic with a request. Any suitable criteria may be used to associate a topic with a request. Control is passed to operation 1915 and process 1900 continues.

In operation 1915, responders are selected. A responder may be selected based on various criteria. A responder may be selected based on availability of a responder, a topic associated with a request, rating of a responder, ranking of a topic, location, a preference for a topic, blocking of a topic, etc. Any user, guide, or person may be selected as a responder. In at least one embodiment, if a request has been offered to a number of responders, a guide may be selected. A guide may be selected as a responder if an expediter or vetter has reviewed a request. A guide may not be selected as a responder based on a user, topic, type, etc. associated with a request. For example, if a request is an opinion request, a guide may not be selected as a responder. Control is passed to operation 1920 and process 1900 continues.

In operation 1920, a responder may be ranked based on request type, responder rating, responder topics, query topics, availability, etc. such as the responder topics illustrated in FIG. 17. A process for ranking responders is further described with respect to FIG. 20. Control is passed to operation 1925 and process 1900 continues.

In operation 1925, a number of responders are notified. A responder may be notified via email, instant messaging, SMS, phone call, notification by an application, or operating system, etc. A responder may be notified of a specific request. A responder may be notified of a topic, category, etc. of a request. A number of responders may be notified based on a type associated with a request. Control is passed to operation 1935 and process 1900 continues.

In operation 1935, a determination is made as to whether an answer is received. If it is determined in operation 1935 that an answer is not received, control is passed to operation 1930 and process 1900 continues. If it is determined in operation 1935 that an answer is received, control is passed to operation 1940 and process 1900 continues.

The determination in operation 1935 may be made using various criteria. If an answer is received from a predetermined number of responders it may be determined that an answer is received. If a time interval has elapsed, it may be determined that an answer is received. If a user has accepted a response, sent a message to a responder, or otherwise responded to an answer, it may be determined that an answer is received. If a number of responders have declined a request, or indicated that a request is inappropriate, it may be determined that an answer is received.

In operation 1930, additional responders are obtained. Additional responders may be selected based on various criteria. A responder may be selected based on availability of a responder, a topic associated with a request, rating of a responder, ranking of a topic, location, a preference for a topic, blocking of a topic, etc. Any user, guide, or person may be selected as a responder. Control is passed to operation 1920 and process 1900 continues.

In operation 1940, an answer is provided. Any number of answers may be provided. A highest ranking objective answer may be provided. A sponsored objective answer may be provided. A sponsored subjective answer may be provided. Control is passed to operation 1945 and process 1900 continues.

In operation 1945, process information is recorded. Information of a request, an objective answer, a subjective answer, a category, a keyword, a resource, a user, a sponsor, a guide, a responder, a rating, a ranking, etc. may be recorded. A stored response may be rated, ranked, or deleted. Usage and compensation associated with a sponsored answer may be recorded. In at least one embodiment, process information is recorded in the database 1420 (FIG. 14). Control is passed to operation 1905 and process 1900 continues.

As illustrated in FIG. 20, a process 2000 for ranking responders is provided. The process 2000 may be performed in whole or in part by any suitable element of the system 1400 (FIG. 14). In at least one embodiment, the process 2000 is operative on a server associated with the search system 1430.

In operation 2005 (FIG. 20) a determination is made as to whether a request is received. If it is determined in operation 2005 that a request is not received, control remains at operation 2005 and process 2000 continues. If it is determined in operation 2005 that a request is received, control is passed to operation 2010 and process 2000 continues.

The determination in operation 2005 may be made using various criteria. In at least one embodiment, if a message is received at a system associated with the search system 1430 (FIG. 14), it may be determined that a request is received. For example, if an email message, an SMS, EMS, and/or MMS message, an IM, an IP message, and/or a voice message is received at an address associated with the search system 1430, it may be determined that a request is received. In at least one embodiment, if a message is received at a server associated with the search system 1430, it may be determined that a request is received.

In operation 2010 topics for a request are obtained. Topics for a request may be obtained from a request record such as the request records 1700a-1700c (FIG. 17). Topics may be associated with a request by a user, responder, and/or automatically. Control is passed to operation 2015 and process 2000 continues.

In operation 2015 ratings of responders for topics are obtained. A rating of a responder may be based on answer quality, time to respond, probability of responding, a time interval since a response, a time interval since a query by a responder, peer review, etc. A type associated with a request may be used to determine a rating of a responder. For example, if a query is associated with an image, audio, or other media, a rating of a responder for a topic may be affected. A rating of a responder may be used for purposes such as determining compensation for the responder, selecting a responder to respond to a request, matching a request to a responder, etc. Control is passed to operation 2020 and process 2000 continues.

In operation 2020, a weighting of topics is determined. A weighting may be assigned to a topic based on various factors. For example, if a large number of responders are associated with a topic and few queries are submitted associated with the topic, a weighting of the topic may be smaller. If a topic is associated with a low degree of domain specific knowledge a weight associated with the topic may be reduced. If a topic is likely to produce a response, a weight associated with a topic may be increased. A weighting of a topic may be determined based on a responder. For example, if a responder is associated with a location and a topic is associated with the location, a weighting of the topic for the responder may be increased. Similarly, if a responder has selected a topic as a favored topic, or is more likely to respond to a query associated with a topic, a weighting of the topic for the responder may be increased. If a responder has a high expertise rating associated with a topic and a query has a low expertise rating associated with a topic, a weighting of a topic for a responder may be reduced. Control is passed to operation 2025 and process 2000 continues.

In operation 2025 responders are ranked based on rating and weighting. A rating and a weighting of a responder for any or all topics associated with a request may be combined to determine a score for a responder for a request. A ranking of a responder for a request may be determined based on a comparison of a rating or score of a responder to ratings of other responders. Any number of responder may be ranked. Guides may be included in a ranking of responders. If a topic is blocked for a responder a responder may be assigned a lowest possible rank. Control is passed to operation 2030 and process 2000 continues.

In operation 2030 a ranking of responders is provided. A ranking of responders may be provided as part of a process such as the process 1900 (FIG. 19). Control is passed to operation 2035 and process 2000 continues.

In operation 2035 process information is recorded. A ranking of responders may be recorded. Weighting of topics associated with a responder may be recorded. Information of a group of responders which were ranked may be recorded. Information of topics, responders, compensation, time, etc. may be stored. In at least one embodiment, process information is recorded in the database 1420 (FIG. 14). Control is passed to operation 2005 and process 2000 continues.

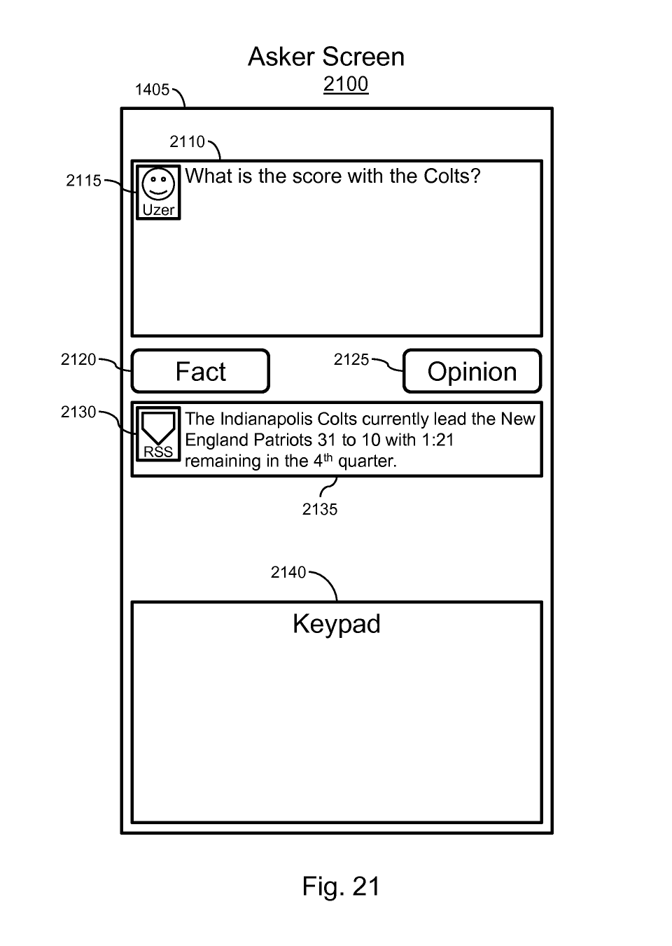

As illustrated in FIG. 21 an exemplary GUI 2100 for submitting a request is provided. The query submission GUI 2100 may be provided to a user. The GUI 2100 may be presented using a system such as the user system 1405 (FIG. 14). The GUI 2100 may be used to submit any type of request. The GUI 2100 may include a query entry area 2110, a user identifier 2115, a factual query indicator 2120, an opinion query indicator 2125, a responder indicator 2130, a response indicator 2135, and a user input control 2140.

The request entry area 2110 may be used to indicate information of a request. The user indicator 2115 may be used to indicate information of a user submitting a request. The factual query indicator 2120 may be used to indicate that a request is a request for factual information. Activation of the factual query indicator 2120 may cause a request indicated in the request entry area 2110 to be associated with the type ‘Fact’. Activation of the opinion query indicator 2125 may indicate that a request is a request for subjective information. The responder indicator 2130 may be used to indicate a source of a response. The response indicator 2135 may be used to indicate a response associated with a request indicated in the request indicator 2110. The user input control 2140 may be used to submit a request. While a keypad is used for purposes of illustration, any user input device which is well known in the art may be used to implement the user input control 2140.

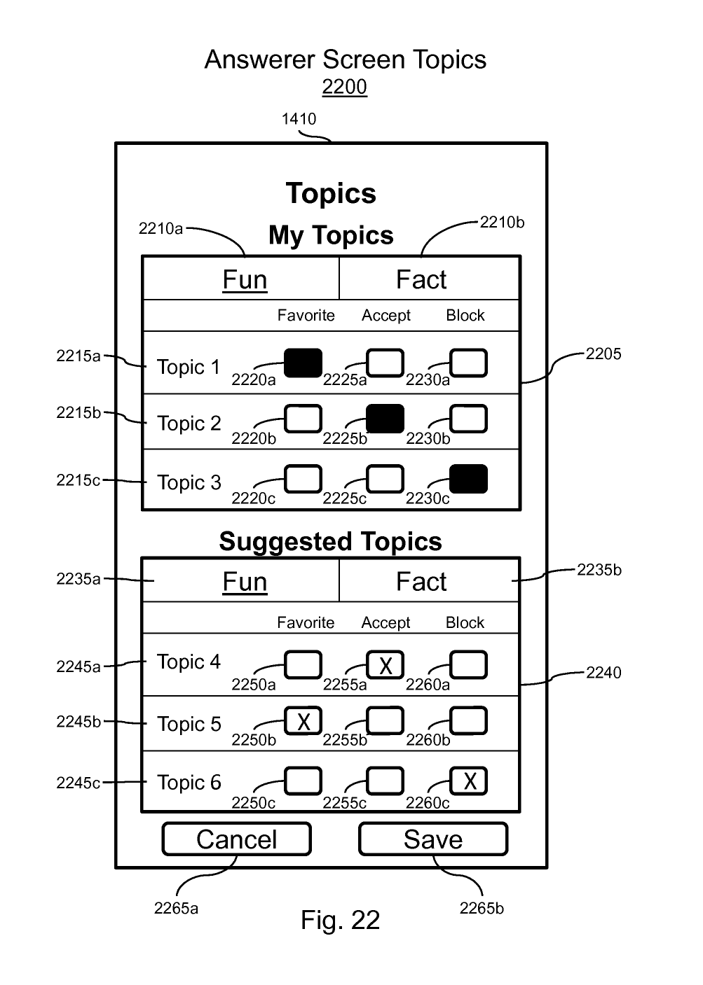

An exemplary GUI 2200 for registering topics is illustrated in FIG. 22. The GUI 2200 may be provided to an answerer via a device such as the user system 1410 (FIG. 14) or the guide system 1435 to register for and/or manage topics. The GUI 2200 may include a registered topic area 2205, registered topic type indicators 2210a, 2210b, registered topic indicators 2215a-2215c, registered favorite indicators 2220a-2220c, registered acceptance indicators 2225a-2225c, registered blocking indicators 2230a-2230c, suggested topic area 2240, suggested topic type indicators 2235a-2235c, suggested topic indicators 2245a-2245c, suggested favorite indicators 2250a-2250c, suggested acceptance indicators 2255a-2255c, suggested blocking indicators 2260a-2260c, and action controls 2265a, 2265b.

The registered topic area 2205 may include information of topics for which a responder has elected to receive requests and/or block requests. The registered topic type indicators 2210a, 2210b may be used to select a type associated with a registered topic. Activation of the ‘Fun’ registered topic indicator 2210a may cause information of topics associated with opinion type queries to be provided. Activation of the ‘Fact’ registered topic indicator 2210b may cause information of topics associated with objective queries to be provided. The ‘Fun’ registered topic type indicator 2210a is active as indicated by the underline in FIG. 22. The registered topic indicators 2215a-2215c may be used to indicate information regarding a registered topic. For example, the ‘Topic 1’ registered topic indicator 2215a may be used to indicate registration status of a responder for ‘Topic 1’. The registered favorite indicators 2220a-2220c may be used to indicate whether a user has indicated that a topic is a favorite. For example the filled rectangle in the registered favorite indicator 2220a may indicate that ‘Topic 1’ is a favorite, while the unfilled rectangles in the registered favorite indicators 2220b, c may indicate ‘Topic 2’ and ‘Topic 3’ are not favorites. Activation of a registered favorite indicator may toggle the status of a registered favorite indicator. The registered acceptance indicators 2225a-2225c may be used to indicate that request associated with a topic will be accepted. For example the filled rectangle in the registered acceptance indicator 2225a may indicate that requests associated with ‘Topic 2’ will be accepted. The registered blocking indicators 2230a-2230c may be used to indicate that requests associated with a topic are to be blocked. For example, the filled rectangle in the registered block indicator 2230c may indicate that requests associated with ‘Topic 3’ are to be blocked. A user may be able to sort topics in the registered topic area 2205 based on whether a topic is a favorite, accepted, or blocked. A search facility may be provided for a user to locate a registered topic. A user may navigate through content of the registered topic area 2205 using typical navigation features.

The suggested topic area 2240 may include information of topics which are recommended for a responder. The suggested topic type indicators 2235a, 2235b may be used to select a type associated with a suggested topic. Activation of the ‘Fun’ suggested topic indicator 2235a may cause information of suggested topics associated with opinion type queries to be provided. Activation of the ‘Fact’ suggested topic indicator 2235b may cause information of topics associated with objective queries to be provided. The ‘Fun’ suggested topic type indicator 2235a is active as indicated by the underline in FIG. 22. The suggested topic indicators 2245a-2245c may be used to indicate information regarding a suggested topic. For example, the ‘Topic 4’ suggested topic indicator 2245a may be used to indicate a type of registration recommended to a responder for ‘Topic 4’. The suggested favorite indicators 2250a-2250c may be used to indicate that a topic is suggested as a favorite as indicated by for example the ‘X’ in the ‘Topic 4’ suggested topic indicator 2255a. A responder may accept a suggestion by activating a suitable suggested topic indicator, which may cause a suggested topic indicator to be indicated by a filled rectangle. A responder may reject a suggestion by activating a suitable suggested topic indicator which may cause a suggested topic indicator to be indicated by an empty rectangle. The suggested acceptance indicators 2255a-2255c may be used to indicate a suggestion that requests associated with a topic will be accepted. For example the ‘X’ in the suggested topic acceptance indicator 2250b may indicate that requests associated with ‘Topic 5’ are recommended to be accepted. The suggested blocking indicators 2260a-2260c may be used to indicate that requests associated with a topic are recommended to be blocked. For example, the ‘X’ in the registered blockade indicator 2260c may indicate that requests associated with ‘Topic 6’ are recommended to be blocked. A user may be able to sort topics in the suggested topic area 2240 based on whether a topic is recommended as a favorite, accepted, or blocked. A search facility may be provided for a user to locate a suggested topic. Suggested topics may be presented in an order based on ranking of suggested topics. A user may navigate through content of the suggested topic area 2240 using typical navigation features as are well known in the art. The action controls 2265a, 2265b may be used to take actions regarding information indicated in the GUI 2200. The ‘Cancel’ action control 2265a may be used to exit the GUI 2200 without saving changes made in the GUI 2200. The ‘Save’ action control 2265b may be used to save information indicated in the GUI 2200.

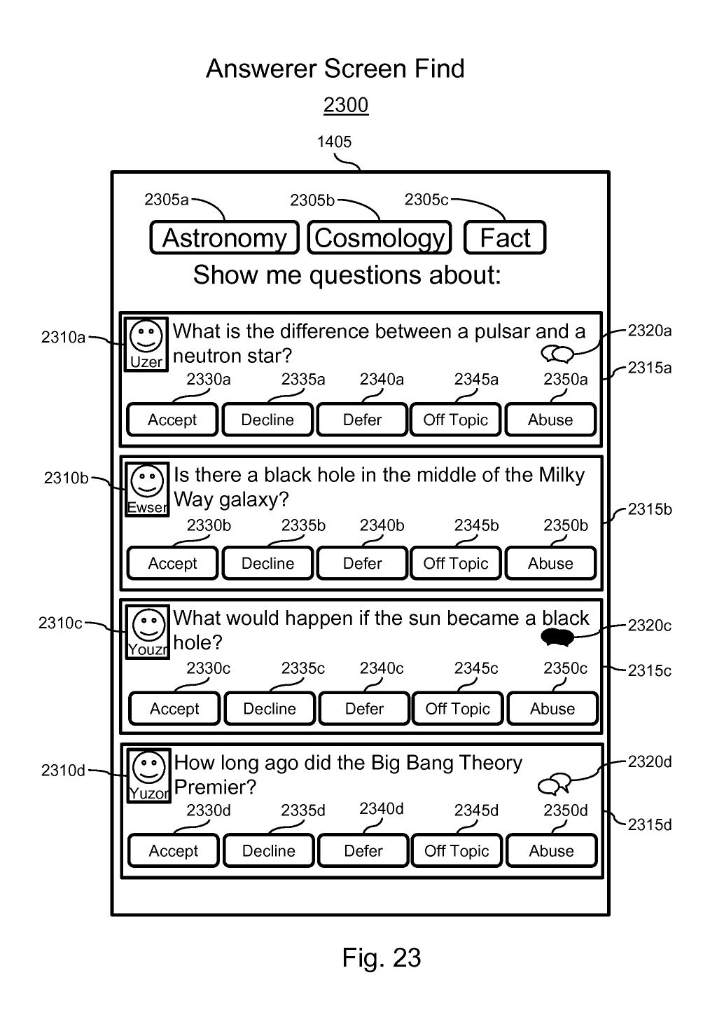

As illustrated in FIG. 23 an exemplary query selection GUI 2300 is provided. The GUI 2300 may be provided to a user, a responder, a guide, etc. The GUI 2300 may be presented using a system such as the user system 1435 (FIG. 14). The GUI 2300 may be used to obtain information of a query. The GUI 2300 may include selection indicators 2305a-2305c, query indicators 2315a-2315d, user indicators 2310a-2310d, conversation indicators 2320a-2320d, acceptance indicators 2330a-2330d, decline indicators 2335a-2335d, defer indicators 2340a-2340d, off topic indicators 2345a-2345d, and abuse indicators 2350a-2350d.

As illustrated in FIG. 23, the topic indicators 2305a-2305c, may include a category, type, etc. which may be used to select a query. The selection indicator 2305a, b may indicate that questions regarding ‘Astronomy’ and ‘Cosmology’ are desired. The selection indicator 2305c may indicate that queries classified as ‘Fact’ are to be provided. The user indicators 2310a-2310d may indicate information of a user associated with a request. For example, the user indicator 2310b shows that ‘Ewser’ has submitted the query ‘Is there a black hole in the middle of the Milky Way galaxy?’ as indicated in the query indicator 2315b. As illustrated in FIG. 23, the conversation indicators 2320a, 2320c, 2320d may indicate that a user associated with a request is available for a two-way communication. For example, the conversation indicator 2320a may indicate that ‘Uzer’ is available for a real-time exchange of information as indicated by the clear speech bubbles in the conversation indicator 2320a. Likewise the absence of a conversation indicator associated with the query indicator 2315b may indicate that communication with a user associated with the query does not accept two-way communications. Similarly the filled conversation indicator 2320c may indicate that a user associated with a query is not currently accepting two-way communication. Any suitable indicator such as color, shading, etc. may be used to indicate status of the conversation indicators 2320a, 2320c, and 2320d.

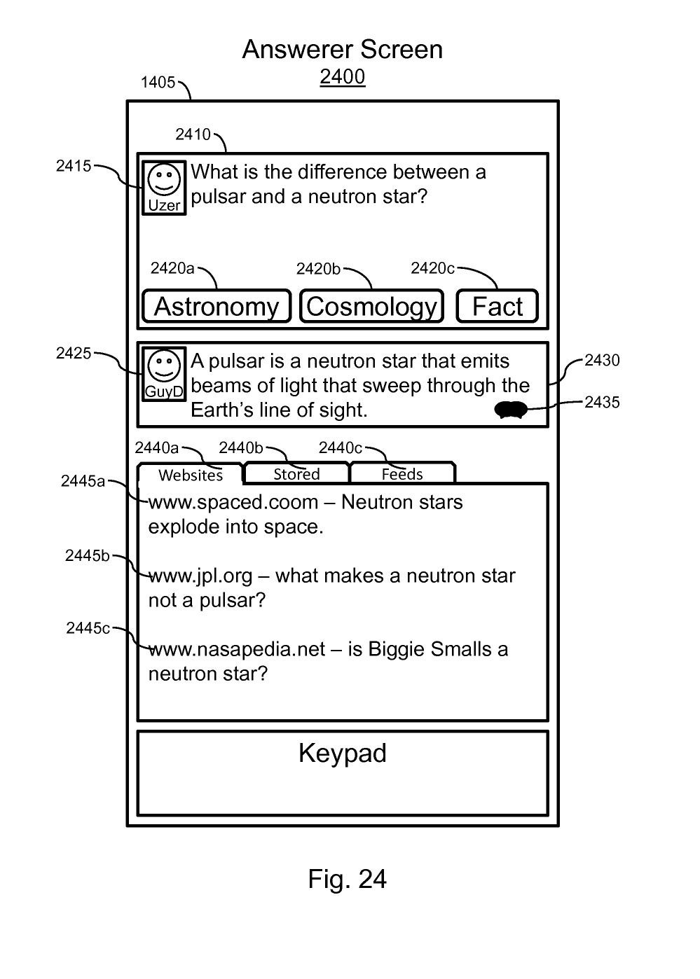

The acceptance indicators 2330a-2330d may be used to indicate that a responder accepts to respond to a request. Activation of the acceptance indicator 2330a may cause a GUI such as the GUI 2400 depicted in FIG. 24 to be provided. Activation of an acceptance indicator may cause a ranking of a topic associated with an accepted query to be increased for a responder. The decline indicators 2335a-2335d may be used to indicate that a responder declines to answer a request. Activation of the decline indicator 2335b may cause the query indicator 2315b to be closed and replaced by a different query indicator. The defer indicators 2340a-2340c may be used to indicate that a responder defers to respond to a request. If a responder activates the defer indicator 2340c, the query indicated in the query indicator 2315c may be replaced, but may be offered to the responder at a later time. The off topic indicators 2345a-2345d may be used to indicate that a query is incorrectly associated with a topic. For example, activation of the off topic indicator 2345d may cause the query indicated by the query indicator 2315d to be ranked lower for the topics ‘Astronomy’, ‘Cosmology’ and ‘Fact’, and may cause the query indicator 2315d to be replaced by another query indicator. The abuse indicators 2350a-2350d may be used to indicate that a request is inappropriate or offensive. Activation of the abuse indicator 2350c may cause a ranking or rating of a user indicated in the user indicator 2310c to be affected, and may cause the query indicator 2315c to be replaced by another query indicator.

An exemplary GUI 2400 for responding to a query is illustrated in FIG. 24. The GUI 2400 may be provided to a responder when a responder elects to respond to a request. The GUI 2400 may be provided using a device such as the user system 1405 (FIG. 14). The GUI 2400 may include a query indicator 2410, a user indicator 2415, query category indicators 2420a-2420c, a responder indicator 2425, a response indicator 2430, a conversation indicator 2435, response type indicators 2440a-2440c, and response indicators 2445a-2445c.

The query indicator 2410 may be used to indicate information of a query to which a responder has chosen to respond. The user indicator 2415 may be used to indicate information of a user associated with a request. The category indicators 2420a-2420c may be used to indicate information associated with a request, which may be used to select requests. The responder indicator 2425 may be used to indicate information of a responder associated with a response indicated in the response indicator 2430. The conversation indicator 2435 may be used to indicate whether a responder indicated in the responder indicator 2425 is accepting messages. Activation of the conversation indicator 2435 may cause a communication session to be established with a responder. The response type indicators 2440a-2440c may be used to indicate a type of response which has been obtained associated with the indicator. For example, the response type indicator 2440a may provide snippets obtained from websites based on any or all elements of a request when activated. The response type indicator 2440b may provide responses associated with stored responses to previous requests which are selected based on any or all elements of a request when activated. The response type indicator 2440c may provide results obtained from RSS feeds, data providers, etc. when activated. The response indicators 2445a-2445c may be used to provide information of responses which may be appropriate.

While the user interfaces described herein have been illustrated using particular types and numbers of interface elements, no limitation is implied thereby, Any number and type of user interface elements as are well known in the art may be used to implement the functionalities described without departing from the scope of the embodiments described herein.

Using the methods and systems described herein a process of ranking a request and distributing a request to responders based on a topic to assign to a responder is described. The system assigns topics to a request and based on a topic assigned chooses a responder to answer. A responder may choose to answer a query and a topic may become ranked higher in a list of topics associated with a responder. A responder may choose to defer and/or not answer a query and a topic may become ranked lower in a list of topics. A responder has the option of listing topics as favorites, and based on this list possible topics may be suggested to a responder. A responder may elect to block requests associated with a topic.

When a request is received topics are assigned to a request. A group of responders associated with topics assigned to a request are rated and ranked based on a weighting of topics for a responder, and a rating of a responder for a topic. A rating of a responder may be affected by temporal information such as a time interval since an action by a responder, a time interval since a last notification of a responder, etc. A number of responders may be notified of a request. A notification may be provided which indicates a particular request and/or a topic or category associated with a request. If an answer is not received, additional responders may be selected for ranking and notification. For example, after a predetermined time period has elapsed a paid responder may be notified of a request, which may cause other responders to be provided with a different request. If an answer is not received with a predetermined time interval, a number of responders decline a request, a request is marked as abusive, etc. a request may be deferred and/or receive an automated response.

A system and method for responding to a request by selecting human responders associated with a topic of a request. Responders may be ranked based on a probability that a responder will reply to a query within a predetermined time interval. Ranking of human responders may be adjusted based on factors such as responsiveness, expertise, and query type.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
receiving a query;
associating a type with the query;
ranking a resource based on the query;
directing a request to the resource based on the ranking; and
providing a response to the query.

2. The method of claim 1 further comprising:
selecting the type based on a number of human responders associated with the type.

3. The method of claim 1 further comprising:
directing the request to a human responder as the resource; and
ranking the responder based on a time interval between receipt of the query and acquisition of a message from the responder.

4. The method of claim 1 further comprising:
assigning a topic to a human responder based on previous responses received from the resource associated with keywords of the topic.

5. The method of claim 1 further comprising:
determining a probability that a resource will respond based on whether the request is seeking subjective information.

6. The method of claim 1 further comprising:
decreasing the ranking of a human responder if the human responder fails to respond to the request within a pre-determined time interval.

7. The method of claim 1 further comprising:
determining a number of resources to which the request is directed based on the type.

8. The method of claim 7 further comprising:
modifying the number when the request is seeking objective information.

9. The method of claim 1 further comprising:
ranking the resource based on a probability that a human responder will provide an answer to requests; and
setting the probability associated with the human responder to zero for a predetermined time interval when the human responder fails to reply to the request within a predetermined time period.

10. The method of claim 9 further comprising:
increasing the time interval when the human responder does not reply to successive requests.

11. The method of claim 1 further comprising:
selecting a keyword as the type; and
determining the keyword based on a number of human responders available for the keyword and a frequency of the keyword in a corpus of queries.

12. The method of claim 1 further comprising:
assigning a topic to the query;
assigning a worth to the query; and
directing the request to the resource based on the topic and the worth.

13. The method of claim 12 further comprising:
assessing the worth of the query based on a number of queries received which indicate the topic and a number of bids associated with an audience which submitted the queries.

14. A system, comprising:
a search system receiving a query, associating a type with the query, ranking a resource based on the query, directing a request to the resource based on the ranking, and providing a response to the query.

15. The system of claim 14, comprising:
a resource system associated with the type, providing keywords to the search system, and providing access to information to responders; and
a responder system receiving access to the resource system based on the ranking of the resource, and receiving a notification of the topic based on a rating of a user of the responder system for the topic.

16. A persistent computer readable medium storing therein a program for causing a computer to execute an operation including creating media content, comprising:
receiving a query;
associating a type with the query;
ranking a resource based on the query;
directing a request to the resource based on the ranking; and
providing a response to the query.

17. The computer readable storage medium of claim 16 wherein the operation further comprises:
assigning a topic to the resource when the resource is a human responder and the human responder provides the response.

18. The computer readable storage medium of claim 16 wherein the operation further comprises:
assigning a topic to the resource when the resource is a human responder and the human responder provides the response.

19. The computer readable storage medium of claim 16 wherein the operation further comprises:
ranking the query based on a cost associated with a human responder and a resource selected for the query;
ranking the query based on temporal information of the query;
ranking the query based on specificity of the query;
ranking the query based on frequency of use of the type in a corpus of requests;
ranking the query based on a level of expertise associated with the query and a group of human responders;
ranking the query based on probability that the response will be used to respond to requests; and
ranking the query based on likelihood that the resource will provide an acceptable response.

20. The computer readable storage medium of claim 16 wherein the operation further comprises:
rating the query based on a worth of a corpus of queries;
evaluating automated responders based on the query;
assessing human responders based on the request;
qualifying compensated human assistants based on the request;
appraising the query based on a corpus of types; and
ranking the resource based on the rating, the evaluating, the assessing, the qualifying, and the appraising.
